(19) United States
(12) Patent Application Publication
(10) Pub. No.: US 2016/0369061 A1
(43) Pub. Date: Dec. 22, 2016

(54) MOISTURE CURABLE COMPOSITIONS

(71) Applicant: MOMENTIVE PERFORMANCE MATERIALS INC, Waterford, NY (US)

(72) Inventor: Sumi DINKAR, Bangalore (IN)

(21) Appl. No.: 14/902,219

(22) PCT Filed: Jul. 2, 2014
(86) PCT No.: PCT/US14/45222

§ 371 Date: Dec. 30, 2015

Related U.S. Application Data
(60) Provisional application No. 61/842,205, filed on Jul. 2, 2013.

(51) Int. Cl. C08G 77/44; C08G 77/08; C08K 5/20; C08K 13/02; C08K 3/36; C08K 5/544

(52) U.S. Cl. CPC C08G 77/44; C08K 3/36; C08K 5/544; C08K 5/20; C08K 13/02; C08G 77/08

(57) ABSTRACT

The present invention provides curable compositions comprising non-tin metal accelerators that accelerate the condensation curing of moisture-curable silicones/non-silicones. In particular, the present invention provides an accelerator comprising amide compounds that are particularly suitable as replacements for organotin in sealant and RTV formulations. Further, the compositions employing an amide compound is comparable or superior to organotin such as DBTDL, exhibits certain behavior in the presence of components that allow for tuning or adjusting the cure characteristics of the compositions, and provides good adhesion and storage stability.

### CROSS REFERENCE TO RELATED APPLICATION

The application claims the benefit of U.S. Provisional Application No. 61/842,205 entitled “Moisture Curable Composition” filed on Jul. 2, 2013, which is hereby incorporated in its entirety by reference.

### FIELD

The present invention relates to curable compositions comprising curable polymers having reactive silyl groups. In particular, the present invention provides curable compositions comprising a metal-free catalyst system as an alternative to organotin or other metal catalysts.

### BACKGROUND

Polymers having reactive silyl groups or compositions comprising such polymers can be hydrolyzed and condensed in the presence of water and organometal catalysts. Suitable known catalysts for curable compositions include organometallic compounds employing metals such as Sn, Ti, Zn, or Ca. Organotin compounds such as, for example, dibutyltin dilaurate (DBTDL) are widely used as condensation cure catalysts to accelerate the moisture-assisted curing of a number of different polyorganosiloxanes and non-silicone polymers having reactive silyl groups such as room temperature vulcanizing (RTV) formulations including RTV-1 and RTV-2 formulations. Environmental regulatory agencies and directives, however, have increased or are expected to increase restrictions on the use of organotin compounds in formulated products. For example, while formulations with greater than 0.5 wt. % dibutyltin presently require labeling as toxic with reproductive 1B classification, dibutyltin-containing formulations are proposed to be completely phased out in consumer applications during the next two to three years.

Alternative organotin compounds such as dioctyltin compounds and dimethyltin compounds can only be considered as a short-term remedial plan, as these organotin compounds may also be regulated in the future. As alternatives to tin catalysts, efforts have been made to identify non-Sn metal-based catalysts that accelerate the condensation curing of moisture-curable silicones and non-silicones. Desirably, substitutes for organotin catalysts should exhibit properties similar to organotin compounds in terms of curing, storage, and appearance. Non-tin catalysts would also desirably initiate the condensation reaction of the selected polymers and complete this reaction upon the surface and may be in the bulk in a desired time schedule. There are therefore many proposals for the replacement of organometallic tin compounds by other organometallic compounds. These compounds comprise metals such as Ca, Ce, Bi, Fe, Mo, Mn, Pb, Ti, V, Zn, and Y. All of these metals have specific advantages and disadvantages in view of replacing tin compounds perfectly. Therefore, there is still a need to overcome some of the weaknesses of possible metal compounds as suitable catalyst for condensation cure reaction including the behavior of uncured and cured compositions to maintain the ability to adhere onto the surface of several substrates. Another problem necessary to be solved in the replacement of organo-tin compounds is for the reactive composition to maintain its ability to cure (when exposed to humidity or ambient air) after storage in a sealed cartridge.

### SUMMARY

The present invention provides tin-free, curable compositions comprising silyl containing polymers and a non-toxic condensation cure accelerator. In one embodiment, the present invention provides curable compositions employing an amide compound as a condensation cure accelerator.

In one embodiment, the curable composition comprises (A) a polymer having at least a reactive silyl group; (B) a crosslinker or chain extender; and (C) a condensation cure accelerator comprising an amide compound. In one embodiment, the amide is of the formula:

R¹⁷ₙJ(O)ₓNR¹⁸R¹⁹ (6)

wherein J is chosen from carbon, phosphorous, and sulfur; x is 1 when J is carbon or phosphorous; x is 2 when J is sulfur; and R¹⁷, R¹⁸, and R¹⁹ are independently chosen from an alkyl, a substituted alkyl, an alkenyl, a substituted alkenyl, an alkynyl, a substituted alyknyl, a carbocycle, a heterocycle, an aryl, a heteroaryl, a substituted organosilane, or a substituted organosiloxane.

In one embodiment, the curable composition comprises from about 0.0001 to about 10 parts per weight (“pt. wt.”) of accelerator (C) per 100 pt. wt. of the polymer (A). In another embodiment, the curable composition comprises from about 0.005 to about 0.05 pt. wt. of accelerator (C) per 100 parts of the polymer (A).

In one aspect, the invention provides a curable composition exhibiting a relatively short tack-free time, curing through the bulk, as well as long storage stability in the cartridge, i.e., in the absence of humidity. Amide compounds, have been unexpectedly found to exhibit curing behavior similar to or even better than organotin compounds, and, therefore, can be suitable as replacements for organotin cure accelerators in compositions having reactive silyl-groups or compositions comprising such polymer that can undergo condensation reactions, such as in RTV-1 and RTV-2 formulations.

Curable compositions using amide compounds may also exhibit certain storage stability of the uncured composition in the cartridge, adhesion onto several surfaces, and a cure rate in a predictable time scheme.

In one aspect, the present invention provides a composition for forming a cured polymer composition comprising: (A) a polymer having at least one reactive silyl group; (B) a crosslinker or chain extender chosen from an alkoxysilane, an alkoxysiloxane, an oximosilane, an oximosiloxane, an enoxysilane, an enoxysiloxane, an aminosilane, an aminosiloxane, a carboxysilane, a carboxysiloxane, an alkylamidosilane, an alkylamidosiloxane, an arylamidosilane, an arylamidosiloxane, an alkoxyaminosilane, an alkoxyaminosiloxane, an alkoxycarbamatosilane, an alkoxycarbamatosiloxane, and combinations of two or more thereof; (C) an accelerator chosen from an amide compound; (D) optionally at least one adhesion promoter chosen from a silane or siloxane other than the compounds listed under (B); (E), optionally, a filler component; and (F) at least one acidic compound chosen from a phosphate ester, a phosphonate ester, a phosphonic acid, a phosphorous acid, a phosphite, a phosphonite ester, a sulfate, a sulfite, a pseudohalogenide, a branched C₄-C₂₅ alkyl carboxylic acid, or a combination of two or more thereof; and (G) an organo functional silane, an organo functional siloxane, a high-boiling solvent, a low molecular-weight organic polymer, and an auxiliary component (H).

In one embodiment, the present invention provides a curable composition that is substantially free of tin.

In one embodiment, the polymer (A) has the formula: [R¹_{c}R²_{3-c}Si—Z—]ₙ—X—Z—SiR¹_{c}R²_{3-c}. In another embodiment, X is chosen from a polyurethane; a polyester; a polyether; a polycarbonate; a polyolefin; a polyesterether; and a polyorganosiloxane having units of R₃SiO_{1/2}, R₂SiO_{2/2}, RSiO_{3/2}, and/or SiO_{4/2}, n is 0 to 100, c is 0 to 2, R, R¹, and R² can be identical or different at the same silicon atom and chosen from C₁-C₁₀ alkyl; C₁-C₁₀ alkyl substituted with one or more of Cl, F, N, O, or S; a phenyl; C₇-C₁₆ alkylaryl; C₇-C₁₆ arylalkyl; C₂-C₂₀-polyalkylene ether; or a combination of two or more thereof. In yet another aspect, R² is chosen from OH, C₁-C₈ alkoxy, C₂-C₁₈ alkoxyalkyl, alkoxyaryl, oximoalkyl, oximoaryl, enoxyalkyl, enoxyaryl, aminoalkyl, aminoaryl, carboxyalkyl, carboxyaryl, amidoalkyl, amidoaryl, carbamatoalkyl, carbamatoaryl, or a combination of two or more thereof, and Z is a bond, a divalent unit selected from the group of a C₁-C₁₄ alkylene, or O.

According to one embodiment, the crosslinker component (B) is chosen from tetraethylorthosilicate (TEOS); a polycondensate of TEOS; methyltrimethoxysilane (MTMS); a polycondensate of MTMS; vinyltrimethoxysilane; methylvinyldimethoxysilane; dimethyldimethoxysilane; dimethyldiethoxysilane; vinyltriethoxysilane; tetra-n-propylorthosilicate; tris(methylethylketoximo)vinylsilane; tris(methylethylketoximo)methylsilane; tris(acetamido)methylsilane; bis(acetamido)dimethylsilane; tris(N-methylacetamido)methylsilane; bis(N-methylacetamido)dimethylsilane; (N-methylacetamido)methyldialkoxysilane; tris(benzamido)methylsilane; tris(propenoxy)methylsilane; alkyldialkoxyamidosilanes; alkylalkoxybisamidosilanes; methylethoxybis(N-methylbenzamido)silane; methylethoxydibenzamidosilane; methyldimethoxy(ethylmethylketoximo)silane; bis(ethylmethylketoximo)methylmethoxysilane; (acetaldoximo)methyldimethoxysilane; (N-methylcarbamato)methyldimethoxysilane; (N-methylcarbamato)ethyldimethoxysilane; (isopropenoxy)methyldimethoxysilane; (isopropenoxy)trimethoxysilane; tris(isopropenoxy)methylsilane; (but-2-en-2-oxy)methyldimethoxysilane; (1-phenylethenoxy)methyldimethoxysilane; 2-((1-carboethoxy)propenoxy)methyldimethoxysilane; bis(N-methylamino)methylmethoxysilane; (N-methylamino)vinyldimethoxysilane; tetrakis(N,N-diethylamino)silane; methyldimethoxy(N-methylamino)silane; methyltris(cyclohexylamino)silane; methyldimethoxy(N-ethylamino)silane; dimethylbis(N,N-dimethylamino)silane; methyldimethoxy(N-isopropylamino)silane dimethylbis(N,N-diethylamino)silane; ethyldimethoxy(N-ethylpropionamido)silane; methyldimethoxy(N-methylacetamido)silane; methyltris(N-methylacetamido)silane; ethyldimethoxy(N-methylacetamido)silane; methyltris(N-methylbenzamido)silane; methylmethoxybis(N-methylacetamido)silane; methyldimethoxy(ε-caprolactamo)silane; trimethoxy(N-methylacetamido)silane; methyldimethoxy(O-ethylacetimidato)silane; methyldimethoxy(O-propylacetimidato)silane; methyldimethoxy(N,N′,N′-trimethylureido)silane; methyldimethoxy(N-allyl-N′,N′-dimethylureido)silane; methyldimethoxy(N-phenyl-N′,N′-dimethylureido)silane; methyldimethoxy(isocyanato)silane; dimethoxydiisocyanatosilane; methyldimethoxyisothiocyanatosilane; methylmethoxydiisothiocyanatosilane; methyltriacetoxysilane; methylmethoxydiacetoxysilane; methylethoxydiacetoxysilane; methylisopropoxydiacetoxysilane; methyl(n-propoxy)diacetoxysilane; methyldimethoxyacetoxysilane; methyldiethoxyacetoxysilane; methyldiisopropoxyacetoxysilane; methyldi(n-propoxy)acetoxysilane; or the condensates thereof; or a combination of two or more thereof.

According to one embodiment, the adhesion promoter component (D) is chosen from an (aminoalkyl)trialkoxysilane, an (aminoalkyl)alkyldialkoxysilane, a bis(trialkoxysilylalkyl)amine, a tris(trialkoxysilylalkyl)amine, a tris(trialkoxysilylalkyl)cyanuarate, a tris(trialkoxysilylalkyl)isocyanurate, an (epoxyalkyl)trialkoxysilane, an (epoxyalkylether)trialkoxysilane, or a combination of two or more thereof.

According to one embodiment, the cure rate modifying component (F) is chosen from a phosphate ester of the formula: (R³O)PO(OH)₂; a phosphite ester of the formula (R³O)P(OH)₂; or a phosphonic acid of the formula: R³P(O)(OH)₂. In another aspect, R³ is a C₁-C₁₈ alkyl, a C₂-C₂₀ alkoxyalkyl, phenyl, a C₇-C₁₂ alkylaryl, a C₂-C₄ polyalkylene oxide ester or its mixtures with diesters; a branched C₄-C₁₄ alkyl carboxylic acid; or a combination of two or more thereof.

According to one embodiment, the composition comprises about 1 to about 10 wt. % of the crosslinker component (B) based on 100 wt. % of the polymer component (A).

According to one embodiment, the crosslinker component (B) is chosen from a silane or a siloxane, the silane or siloxane having two or more reactive groups that can undergo hydrolysis and/or condensation reaction with polymer (A) or on its own in the presence of water and cure rate modifying component (F).

According to one embodiment, the polymer component (A) is chosen from a polyorganosiloxane comprising divalent units of the formula [R₂SiO] in the backbone, wherein R is chosen from C₁-C₁₀ alkyl; C₁-C₁₀ alkyl substituted with one or more of Cl, F, N, O, or S; phenyl; C₇-C₁₆ alkylaryl; C₇-C₁₆ arylalkyl; C₂-C₂₀ polyalkylene ether; or a combination of two or more thereof.

According to one embodiment, the condensation accelerator (C) is present in an amount of from about 0.1 to about 7 pt. wt. per 100 pt. wt. of component (A).

According to one embodiment, the cure rate modifying component (F) is present in an amount of from about 0.02 to about 7 pt. wt. per 100 pt. wt. of component (A).

According to one embodiment, the polymer component (A) has the formula:

R²_{3-c}R¹_{c}Si—X—[R₂SiO]ₓ—[R¹₂SiO]_{y}—X—SiR¹_{c}R²_{3-c} whereby x is 0 to 10,000; y is 0 to 10,000; c is 0 to 2; R is methyl. In another aspect, R¹ is chosen from a C₁-C₁₀ alkyl; a alkyl substituted with one or more of Cl, F, N, O, or S; a phenyl; a C₇-C₁₆ alkylaryl; a C₇-C₁₆ arylalkyl; a C₂-C₂₀ polyalkylene ether; or a combination of two or more thereof, and other siloxane units may be present in amounts less than 10 mol. % preferably methyl, vinyl, phenyl. In yet another embodiment, R² is chosen from OH, a C₁-C₈ alkoxy, a C₂-C₁₈ alkoxyalkyl, an oximoalkyl, an enoxyalkyl, an aminoalkyl, a carboxyalkyl, an amidoalkyl, an amidoaryl, a carbamatoalkyl, or a combination of two or more thereof, and Z is —O—, a bond, or C₂H₄.

According to one embodiment, the composition further comprises a solvent chosen from an alkylbenzene, a trialkylphosphate, a triarylphosphate, a phthalic acid ester, an arylsulfonic acid ester having a viscosity-density constant (VDC) of at least 0.86 that is miscible with a polyorganosiloxane and accelerator component (C), a polyorganosiloxane devoid of reactive groups and having a viscosity of less than 2000 mPa·s at 25° C., or a combination of two or more thereof.

According to one embodiment, the composition is provided as a one-part composition.

According to one embodiment, the composition comprises 100 wt. % of component (A), 0.1 to about 10 wt. % of at least one crosslinker (B), 0.01 to about 7 wt. % of an accelerator (C), 0.1 to about 15 wt. % of an adhesion promoter (D), 0 to about 300 wt. % of component (E), 0.01 to about 8 wt. % of cure rate modifying component (F), 0 to 15 wt. % organofunctional siloxane, a high-boiling-point solvent, a low-molecular-weight organic polymer, or a combination of two or more thereof (G), whereby this composition can be stored in the absence of humidity and is curable in the presence of humidity upon exposure to ambient air.

According to one embodiment, the composition is a two-part composition comprising: (i) a first portion comprising the polymer component (A), optionally the filler component (E), and optionally the acidic compound (F); and (ii) a second portion comprising the crosslinker (B), the cure accelerator component (C), the adhesion promoter (D), and the acidic compound (F), an organo-functional silane, an organo-functional siloxane, a high-boiling-point solvent, a low-molecular-weight organic polymer, or a combination of two or more thereof (G), whereby (i) and (ii) are stored separately until applied for curing by mixing of the components (i) and (ii).

According to one embodiment, portion (i) comprises 100 wt. % of component (A), and 0 to 70 pt. wt. of component (E); and portion (ii) comprises 0.1 to 10 pt. wt. of at least one crosslinker (B), 0.01 to 7 pt. wt. of an accelerator (C), 0 to 10 pt. wt. of an adhesion promoter (D), and 0.001 to 3 pt. wt. cure rate modifying component (F).

According to one embodiment, portion (i) comprises 100 wt. % of component (A), 0 to 70 pt. wt. of component (E); and portion, comprises 0.1 to 10 pt. wt. of at least one crosslinker (B), 0.001 to 3 pt. wt. cure rate modifying component (F) and portion comprises (ii) 0.01 to 7 pt. wt. of an accelerator (C), optionally 0 to 10 pt. wt. of an adhesion promoter (D), optionally 0-15 pt. wt. of an organo-functional silane, an organo-functional siloxane, a high-boiling-point solvent, a low-molecular-weight organic polymer, or a combination of two or more thereof (G), optionally 0.01 to 3 pt. wt. of an auxiliary component (H).

In another aspect, the present invention provides, a composition for forming a cured polymer composition comprising (A) a polymer having at least a reactive silyl group, where the polymer is free of siloxane bonds; (B) a crosslinker or chain extender chosen from an alkoxysilane, an alkoxysiloxane, an oximosilane, an oximosiloxane, an enoxysilane, an enoxysiloxane, an aminosilane, an aminosiloxane, a carboxysilane, a carboxysiloxane, an alkylamidosilane, an alkylamidosiloxane, an arylamidosilane, an arylamidosiloxane, an alkoxyaminosilane, an alklarylaminosiloxane, an alkoxycarbamatosilane, an alkoxycarbamatosiloxane, the condensates thereof, and combinations of two or more thereof; and (C) a condensation accelerator comprising an amide compound.

In another aspect, the present invention provides a method of providing a cured material comprising exposing the composition to ambient air.

According to one embodiment, a method of providing a cured material comprises combining the first portion and the second portion and curing the mixture.

According to one embodiment, the composition is stored in a sealed cartridge or flexible bag having outlet nozzles for extrusion and/or shaping of the uncured composition prior to cure.

In still another aspect, the present invention provides a cured polymer material formed from the composition.

According to one embodiment, the cured polymer material is in the form of an elastomeric or duromeric seal, an adhesive, a coating, an encapsulant, a shaped article, a mold, and an impression material.

In another aspect, the present invention provides a composition for forming a cured polymer composition comprising (A) a polymer having a reactive silyl group, (C) an amide, (D) an adhesion promoter, and (G) an organo-functional silane, an organo-functional siloxane, a high-boiling-point solvent, a low-molecular-weight organic polymer, or a combination of two or more thereof, where the component (G) includes a compound having at least one hydridosilyl group.

The compositions are found to exhibit good storage stability and adhere to a variety of surfaces. In one embodiment, the curable compositions exhibit excellent adherence to thermoplastic surfaces.

### DETAILED DESCRIPTION

The present invention provides a curable composition employing an amide compound as a condensation cure accelerator. Compositions comprising amide compounds exhibit good curing properties and can even exhibit similar or superior curing properties compared to compositions employing organotin compounds, such as DBTDL, in terms of accelerating moisture-assisted condensation curing of silicones to result in crosslinked silicones that can be used as sealants and RTVs (Room-Temperature Vulcanized Rubber). Further, the compositions comprising amide compounds also exhibit improved storage stability.

As used herein, “alkyl” includes straight, branched and cyclic alkyl groups. Specific and non-limiting examples of alkyls include, but are not limited to, methyl, ethyl, propyl, isobutyl, ethyl-hexyl, cyclohexyl, etc.

As used herein, “substituted alkyl” includes an alkyl group that contains one or more substituent groups that are inert under the process conditions to which the compound containing these groups is subjected. The substituent groups also do not substantially interfere with the process. As used herein, unsubstituted means the particular moiety carries hydrogen atoms on its constituent atoms, e.g. CH₃ for unsubstituted methyl. Substituted means that the group can carry typical functional groups known in organic chemistry.

As used herein, “aryl” includes a non-limiting group of any aromatic hydrocarbon from which one hydrogen atom has been removed. An aryl may have one or more aromatic rings, which may be fused, connected by single bonds or other groups. Specific and non-limiting examples of aryls include, but are not limited to, tolyl, xylyl, phenyl, naphthalenyl, etc.

As used herein, “substituted aryl” includes an aromatic group substituted as set forth in the above definition of “substituted alkyl.” Similar to an aryl, a substituted aryl may have one or more aromatic rings, which may be fused, connected by single bonds or other groups; however, when the substituted aryl has a heteroaromatic ring, the free valence in the substituted aryl group can be a heteroatom (such as nitrogen) of the heteroaromatic ring instead of a carbon. In one embodiment, substituted aryl groups herein contain 1 to about 30 carbon atoms.

As used herein, “alkenyl” includes any straight, branched, or cyclic alkenyl group containing one or more carbon-carbon double bonds, where the point of substitution can be either a carbon-carbon double bond or elsewhere in the group. Specific and non-limiting examples of alkenyls include, but are not limited to, vinyl, propenyl, allyl, methallyl, ethylidenyl norbornane, etc.

As used herein, “alkynyl” includes any straight, branched, or cyclic alkynyl group containing one or more carbon-carbon triple bonds, where the point of substitution can be either at a carbon-carbon triple bond or elsewhere in the group.

As used herein, “unsaturated” refers to one or more double or triple bonds. In one embodiment, it refers to carbon-carbon double or triple bonds.

In one embodiment, the present invention provides a curable composition comprising a polymer component (A) comprising a reactive silyl group; a crosslinker component (B); a cure accelerator component (C) comprising an amide compound; optionally an adhesion promoter component (D); an optional filler component (E); an optional acidic compound (F); an organo-functional silane, an organo-functional siloxane, a high-boiling-point solvent, a low-molecular-weight organic polymer, or a combination of two or more thereof (G); and optionally an auxiliary component (H).

The polymer component (A) may be a liquid or solid-based polymer having a reactive silyl group. The polymer component (A) is not particularly limited and may be chosen from any cross-linkable polymer as may be desired for a particular purpose or intended use. Non-limiting examples of suitable polymers for the polymer component (A) include polyorganosiloxanes (A1) or organic polymers free of siloxane bonds (A2), wherein the polymers (A1) and (A2) comprise reactive silyl groups. In one embodiment, the polymer component (A) may be present in an amount of from about 10 to about 90 wt. % of the curable composition. In one embodiment, the curable composition comprises about 100 pt. wt. of the polymer component (A).

As described above, the polymer component (A) may include a wide range of polyorganosiloxanes. In one embodiment, the polymer component may comprise one or more polysiloxanes and copolymers of formula (1):

[R¹_{c}R²_{3-c}Si—Z—]ₙ—X—Z—SiR¹_{c}R²_{3-c} (1)

R¹ may be chosen from linear or branched alkyl, linear or branched heteroalkyl, cycloalkyl, heterocycloalkyl, aryl, heteroaryl, linear or branched aralkyl, linear or branched heteroaralkyl, or a combination of two or more thereof. In one embodiment, R¹ may be chosen from C₁-C₁₀ alkyl; C₁-C₁₀ alkyl substituted with one or more of Cl, F, N, O, or S; phenyl; C₇-C₁s alkylaryl; C₇-C₁₆ arylalkyl; C₂-C₂₀ polyalkylene ether; or a combination of two or more thereof. Exemplary groups are methyl, trifluoropropyl, and/or phenyl groups.

R² may be a group reactive to protic agents such as water. Exemplary groups for R² include OH, alkoxy, alkenyloxy, alkyloximo, alkylcarboxy, arylcarboxy, alkylamido, arylamido, or a combination of two or more thereof. In one embodiment, R² is chosen from OH, C₁-C₈ alkoxy, C₂-C₁₈ alkoxyalkyl, amino, alkenyloxy, alkyloximo, alkylamino, arylamino, alkylcarboxy, arylcarboxy, alkylamido, arylamido, alkylcarbamato, arylcarbamato, or a combination of two or more thereof.

Z may be a bond, a divalent linking unit selected from the group of O, hydrocarbons which can contain one or more O, S, or N atom, amide, urethane, ether, ester, urea units or a combination of two or more thereof. If the linking group Z is a hydrocarbon group, then Z is linked to the silicon atom over a silicon-carbon bond. In one embodiment, Z is chosen from a C₁-C₁₄ alkylene.

X is chosen from a polyurethane; a polyester; a polyether; a polycarbonate; a polyolefin; a polyesterether; and a polyorganosiloxane having units of R¹₃SiO_{1/2}, R¹₂SiO, R¹SiO_{3/2}, and/or SiO₂, where R¹ is defined as above. X may be a divalent or multivalent polymer unit selected from the group of siloxy units linked over oxygen or hydrocarbon groups to the terminal silyl group comprising the reactive group R² as described above, polyether, alkylene, isoalkylene, polyester, or polyurethane units linked over hydrocarbon groups to the silicon atom comprising one or more reactive groups R² as described above. The hydrocarbon group X can contain one or more heteroatoms such as N, S, O, or P forming amides, esters, ethers, urethanes, esters, and/or ureas. In one embodiment, the average polymerization degree (Pₙ) of X should be more than 6, e.g. polyorganosiloxane units of R¹₃SiO_{1/2}, R¹₂SiO_{2/2}, R¹SiO_{3/2}, and/or SiO_{4/2}. In formula (1), n is 0 to 100; desirably 1, and c is 0 to 2, desirably 0 to 1.

Non-limiting examples of the components for unit X include polyoxyalkylene polymers such as polyoxyethylene, polyoxypropylene, polyoxybutylene, polyoxyethylene-polyoxypropylene copolymer, polyoxytetramethylene, or polyoxypropylene-polyoxybutylene copolymer; ethylene-propylene copolymer, polyisobutylene, polychloroprene, polyisoprene, polybutadiene, copolymer of isobutylene and isoprene, copolymers of isoprene or butadiene and acrylonitrile and/or styrene, or hydrocarbon polymers such as hydrogenated polyolefin polymers produced by hydrogenating these polyolefin polymers; polyester polymer manufactured by a condensation of dibasic acid such as adipic acid or phthalic acid and glycol, or ring-opening polymerization of lactones; polyacrylic acid ester produced by radical polymerization of a monomer such as C₂-C₈-alkyl acrylates, vinyl polymers, e.g., acrylic acid ester copolymer of acrylic acid ester such as ethyl acrylate or butyl acrylate and vinyl acetate, acrylonitrile, methyl methacrylate, acrylamide, or styrene; graft polymer produced by polymerizing the above organic polymer with a vinyl monomer; polycarbonates; polysulfide polymer; polyamide polymer such as Nylon 6 produced by ring-opening polymerization of ε-caprolactam, Nylon 6-6 produced by polycondensation of hexamethylenediamine and adipic acid, etc., Nylon 12 produced by ring-opening polymerization of ε-laurolactam, copolymeric polyamides, polyurethanes, or polyureas.

Particularly suitable polymers include, but are not limited to, polysiloxanes, polyoxyalkylenes, saturated hydrocarbon polymers such as polyisobutylene, hydrogenated polybutadiene and hydrogenated polyisoprene, or polyethylene, polypropylene, polyesters, polycarbonates, polyurethanes, polyurea polymers and the like. Furthermore, saturated hydrocarbon polymer, polyoxyalkylene polymer, and vinyl copolymer are particularly suitable due to their low glass transition temperature which provide a high flexibility at low temperatures, i.e., below 0° C.

The reactive silyl groups in formula (1) can be introduced by employing silanes containing a functional group which has the ability to react by known methods with unsaturated hydrocarbons via hydrosilylation, or reaction of SiOH, aminoalkyl or -aryl, HOOC-alkyl or -aryl, HO-alkyl or -aryl, HS-alkyl or -aryl, Cl(O)C-alkyl or -aryl, epoxyalkyl or epoxycycloalkyl groups in the prepolymer to be linked to a reactive silyl group via condensation or ring-opening reactions. Examples of the main embodiments include the following:

(i) siloxane prepolymers having a SiOH group that can undergo a condensation reaction with a silane (L-group) SiR¹_{c}R²_{3-c} whereby a siloxy bond ═Si—O—SiR¹_{c}R²_{3-c} is formed while the addition product of the leaving group (L-group) and hydrogen is released (L-group+H);
(ii) silanes having an unsaturated group that is capable of reacting via hydrosilylation or radical reaction with a SiH group or radically activated groups of a silane such as SiH or an unsaturated group; and
(iii) silanes including organic or inorganic prepolymers having OH, SH, amino, epoxy, —COCl, —COOH groups, which can react complementarily with epoxy, isocyanato, OH, SH, cyanato, carboxylic halogenides, reactive alkylhalogenides, lactones, lactams, or amines, that is to link the reactive prepolymer with the organofunctional silanes to yield a silyl functional polymer.

Silanes suitable for method (i) include alkoxysilanes, especially tetraalkoxysilanes, di- and trialkoxysilanes, di- and triacetoxysilanes, di- and triketoximosilanes, di- and trialkenyloxysilanes, di- and tricarbonamidosilanes, wherein the remaining residues at the silicon atom of the silane are substituted or unsubstituted hydrocarbons. Other non-limiting silanes for method (i) include alkyltrialkoxysilanes, such as vinyltrimethoxysilane, methyltrimethoxysilane, propyltrimethoxysilane, aminoalkyltrimethoxysilane, ethyltriacetoxysilane, methyl- or propyltriacetoxysilane, methyltributanonoximosilane, methyltripropenyloxysilane, methyltribenzamidosilane, or methyltriacetamidosilane. Prepolymers suitable for reaction under method (i) are SiOH-terminated polyalkylsiloxanes, which can undergo a condensation reaction with a silane having hydrolyzable groups attached to the silicon atom. Exemplary SiOH-terminated polyalkyldisiloxanes include polydimethylsiloxanes.

Suitable silanes for method (ii) include alkoxysilanes, especially trialkoxysilanes (HSi(OR)₃) such as trimethoxysilane, triethoxysilane, methyldiethoxysilane, methyldimethoxysilane, and phenyldimethoxysilane. Hydrogenchlorosilanes are in principle possible but are less desirable due to the additional replacement of the halogen through an alkoxy, acetoxy group, etc. Other suitable silanes include organofunctional silanes having unsaturated groups which can be activated by radicals, such as vinyl, allyl, mercaptoalkyl, or acrylic groups. Non-limiting examples include vinyltrimethoxysilane, mercaptopropyltrimethoxysilane, and methacryloxypropyltrimethoxysilane. Prepolymers suitable for reaction under method (ii) include vinyl-terminated polyalkylsiloxanes, preferably polydimethylsiloxanes, hydrocarbons with unsaturated groups which can undergo hydrosilylation or can undergo radically induced grafting reactions with a corresponding organofunctional group of a silane comprising, for example, unsaturated hydrocarbon or a —SiH group.

Another method for introducing silyl groups into hydrocarbon polymers can be the copolymerization of unsaturated hydrocarbon monomers with the unsaturated groups of silanes. The introduction of unsaturated groups into a hydrocarbon prepolymer may include, for example, the use of alkenyl halogenides as chain stopper after polymerization of the silicon free hydrocarbon moiety.

Desirable reaction products between the silanes and prepolymers include the following structures: —SiR¹₂O—SiR¹₂—CH₂—CH₂—SiR¹_{c}R²_{3-c}, or (hydrocarbon)-[Z—SiR¹_{c}R²_{3-c}]ₙ. Suitable silanes for method (iii) include, but are not limited to, alkoxysilanes, especially silanes having organofunctional groups to be reactive to —OH, —SH, amino, epoxy, —COCl, or —COOH.

In one embodiment, these silanes have an isocyanatoalkyl group such as gamma-isocyanatopropyltrimethoxysilane, gamma-isocyanatopropylmethyldimethoxysilane, gamma-isocyanatopropyltriethoxysilane, gamma-glycidoxypropylethyldimethoxysilane, gamma-glycidoxypropyltrimethoxysilane, gamma-glycidoxypropyltriethoxysilane, beta-(3,4-epoxycyclohexyl)ethyltrimethoxysilane, beta-(3,4-epoxycyclohexyl)ethyltriethoxysilane, epoxylimonyltrimethoxysilane, N-(2-aminoethyl)-aminopropyltrimethoxysilane, gamma-aminopropyltriethoxysilane, gamma-aminopropyltrimethoxysilane, gamma-aminopropylmethyldimethoxysilane, gamma-aminopropylmethyldiethoxysilane, etc.

In one embodiment, it is desirable to select either blocked amines or isocyanates (Z′—X)ₙ—Z′ for carrying out first a complete mixing and then the following coupling reaction. Examples of blocking agents are disclosed in EP 0947531 and other blocking procedures that employ heterocyclic nitrogen compounds such as caprolactam or butanone oxime, or cyclic ketones referred to in U.S. Pat. No. 6,827,875 both of which are incorporated herein by reference in their entirety.

Examples of suitable prepolymers for a reaction under method (iii) include, but are not limited to, polyalkylene oxides having OH groups, in one embodiment with a high molecular weight (M_{w}, weight-average molecular weight >6000 g/mol) and a polydispersity M_{w}/Mₙ of less than 1.6; urethanes having remaining NCO groups, such as NCO functionalized polyalkylene oxides, especially blocked isocyanates. Prepolymers selected from the group of hydrocarbons having —OH, —COOH, amino, epoxy groups, which can react complementarily with an epoxy, isocyanato, amino, carboxyhalogenide or halogenalkyl group of the corresponding silane having further reactive groups useful for the final cure.

Suitable isocyanates for the introduction of a NCO group into a polyether may include toluene diisocyanate, diphenylmethane diisocyanate, or xylene diisocyanate, or aliphatic polyisocyanate such as isophorone diisocyanate, or hexamethylene diisocyanate.

The polymerization degree of the unit X depends on the requirements of viscosity and mechanical properties of the cured product. If X is a polydimethylsiloxane unit, the average polymerization degree based on the number average molecular weight Mₙ is preferably 7 to 5000 siloxy units, preferably 200 to 2000 units. In order to achieve a sufficient tensile strength of >5 MPa, an average polymerization degree Pₙ of >250 is suitable whereby the polydimethylsiloxanes have a viscosity of more than 300 mPa·s at 25° C. If X is a hydrocarbon unit other than a polysiloxane unit, the viscosity with respect to the polymerization degree is much higher.

Examples of the method for synthesizing a polyoxyalkylene polymer include, but are not limited to, a polymerization method using an alkali catalyst such as KOH, a polymerization method using a metal-porphyrin complex catalyst such as a complex obtained by reacting an organoaluminum compound, a polymerization method using a composite metal cyanide complex catalyst disclosed, e.g., in U.S. Pat. Nos. 3,427,256; 3,427,334; 3,278,457; 3,278,458; 3,278,459; 3,427,335; 6,696,383; and 6,919,293.

If the group X is selected from hydrocarbon polymers, then polymers or copolymers having isobutylene units are particularly desirable due to its physical properties such as excellent weatherability, excellent heat resistance, and low gas and moisture permeability.

Examples of the monomers include olefins having 4 to 12 carbon atoms, vinyl ether, aromatic vinyl compound, vinylsilanes, and allylsilanes. Examples of the copolymer component include 1-butene, 2-butene, 2-methyl-1-butene, 3-methyl-1-butene, pentene, 4-methyl-1-pentene, hexene, vinylcyclohexene, methylvinyl ether, ethyl vinyl ether, isobutyl vinyl ether, styrene, alpha-methylstyrene, dimethylstyrene, beta-pinene, indene, and for example, but not limited to, vinyltrialkoxysilanes, e.g. vinyltrimethoxysilane, vinylmethyldichlorosilane, vinyldimethylmethoxysilane, divinyldichlorosilane, divinyldimethoxysilane, allyltrichlorosilane, allylmethyldichlorosilane, allyldimethylmethoxysilane, cliallyldichlorosilane, diallyldimethoxysilane, gamma-methacryloyloxypropyltrimethoxysilane, and gamma-methacryloyloxypropylmethyldimethoxysilane.

Examples of suitable siloxane-free organic polymers include, but are not limited to, silylated polyurethane (SPUR), silylated polyester, silylated polyether, silylated polycarbonate, silylated polyolefins like polyethylene, polypropylene, silylated polyesterether and combinations of two or more thereof. The siloxane-free organic polymer may be present in an amount of from about 10 to about 90 wt. % of the composition or about 100 pt. wt.

In one embodiment, the polymer component (A) may be silylated polyurethane (SPUR). Such moisture curable compounds are known in the art in general and can be obtained by various methods including (i) reacting an isocyanate-terminated polyurethane (PUR) prepolymer with a suitable silane, e.g., one possessing both hydrolyzable functionality at the silicon atom, such as, alkoxy, etc., and secondly active hydrogen-containing functionality such as mercaptan, primary or secondary amine, preferably the latter, etc., or by (ii) reacting a hydroxyl-terminated PUR (polyurethane) prepolymer with a suitable isocyanate-terminated silane, e.g., one possessing one to three alkoxy groups. The details of these reactions, and those for preparing the isocyanate-terminated and hydroxyl-terminated PUR prepolymers employed therein can be found in, amongst others: U.S. Pat. Nos. 4,985,491; 5,919,888; 6,207,794; 6,303,731; 6,359,101; and 6,515,164, and published U.S. Patent Publication Nos. 2004/0122253 and US 2005/0020706 (isocyanate-terminated PUR prepolymers); U.S. Pat. Nos. 3,786,081 and 4,481,367 (hydroxyl-terminated PUR prepolymers); U.S. Pat. Nos. 3,627,722; 3,632,557; 3,971,751; 5,623,044; 5,852,137; 6,197,912; and 6,310,170 (moisture-curable SPUR (silane modified/terminated polyurethane) obtained from reaction of isocyanate-terminated PUR prepolymer and reactive silane, e.g., aminoalkoxysilane); and, U.S. Pat. Nos. 4,345,053; 4,625,012; 6,833,423; and published U.S. Patent Publication 2002/0198352 (moisture-curable SPUR obtained from reaction of hydroxyl-terminated PUR prepolymer and isocyanatosilane). The entire contents of the foregoing U.S. patent documents are incorporated by reference herein. Other examples of moisture-curable SPUR materials include those described in U.S. Pat. No. 7,569,653, the disclosure of which is incorporated by reference in its entirety.

In one embodiment, the polymer component (A) may be a polymer of formula (2):

R²_{3-c}R¹_{c}Si—Z—[R₂SiO]ₓ[R¹₂SiO]_{y}—Z—SiR¹_{c}R²_{3-c} (2)

wherein R¹, R², Z, and c are defined as above with respect to formula (2); R is C₁-C₆ alkyl (an exemplary alkyl being methyl); x is 0 to about 10,000, in one embodiment from 11 to about 2500; and y is 0 to about 10,000; preferably 0 to 500. In one embodiment, Z in a compound of formula (2) is a bond or a divalent C₁-C₁₄ alkylene group, especially preferred is —C₂H₄—.

In one embodiment, the polymer component (A) may be a polyorganosiloxane of the formula (3):

R²_{3-c-d}SiR³_{c}R⁴_{d}—[OSiR³R⁴]ₓ—[OSiR³R⁴]_{y}—OSiR³ₑR⁴_{f}R²_{3-e-f} (3)

R³ and R⁴ can be identical or different on the same silicon atom and are chosen from hydrogen; C₁-C₁₀ alkyl; C₁-C₁₀ heteroalkyl, C₃-C₁₂ cycloalkyl; C₂-C₃₀ heterocycloalkyl; C₆-C₁₃ aryl; C₇-C₃₀ alkylaryl; C₇-C₃₀ arylalkyl; C₄-C₁₂ heteroaryl; C₅-C₃₀ heteroarylalkyl; C₅-C₃₀ heteroalkylaryl; C₂-C₁₀₀ polyalkylene ether; or a combination of two or more thereof. R², c, x, and y are as defined above; d is 0, 1, or 2; e is 0, 1, or 2; and f is 0, 1, or 2.

Non-limiting examples of suitable polysiloxane-containing polymers (A1) include, for example, silanol-stopped polydimethylsiloxane, silanol or alkoxy-stopped polyorganosiloxanes, e.g., methoxystopped polydimethylsiloxane, alkoxy-stopped polydimethylsiloxane-polydiphenylsiloxane copolymer, and silanol or alkoxy-stopped fluoroalkyl-substituted siloxanes such as poly(methyl 3,3,3-trifluoropropyl)siloxane and poly(methyl 3,3,3-trifluoropropyl)siloxane-polydimethyl siloxane copolymer. The polyorganosiloxane component (A1) may be present in an amount of about 10 to about 90 wt. % of the composition or 100 pt. wt. In one preferred embodiment, the polyorganosiloxane component has an average chain length in the range of about 10 to about 2500 siloxy units, and the viscosity is in the range of about 10 to about 500,000 mPa·s at 25° C.

Alternatively, the composition may include silyl-terminated organic polymers (A2) that are free of siloxane units, and which undergo curing by a condensation reaction comparable to that of siloxane containing polymers (A1). Similar to the polyorganosiloxane polymer (A1), the organic polymers (A2) that are suitable as the polymer component (A) include a terminal silyl group. In one embodiment, the terminal silyl group may be of the formula (4):

—SiR¹_{d}R²_{3-d} (4)

wherein R¹, R², and d are as defined above.

The polysiloxane composition may further include a crosslinker or a chain extender as component (B). In one embodiment, the crosslinker is of the formula (5):

R¹_{d}SiR²_{4-d} (5)

wherein R¹, R², and d are as defined above. Alternatively, the crosslinker component may be a condensation product of formula (5) wherein one or more but not all R² groups are hydrolyzed and released in the presence of water and then intermediate silanols undergo a condensation reaction to give a Si—O—Si bond and water. The average polymerization degree can result in a compound having 2 to 10 Si units.

In one embodiment, the crosslinker is an alkoxysilane having a formula R³_{d}(R¹O)_{4-d}Si, wherein R¹, R³, and d are defined as above. In another embodiment, the crosslinker is an acetoxysilane having a formula (R³_{d}(R₁CO₂)_{4-d}Si, wherein R¹, R³, and d are defined as above. In still another embodiment, the crosslinker is an oximosilane having a formula R³_{d}(R¹R⁴C═N—O)_{4-d}Si, where R¹, R³, R⁴, and d are defined as above.

As used herein, the term crosslinker includes a compound including an additional reactive component having at least two hydrolysable groups and less than three silicon atoms per molecule not defined under (A). In one embodiment, the crosslinker or chain extender may be chosen from an alkoxysilane, an alkoxysiloxane, an oximosilane, an oximosiloxane, an enoxysilane, an enoxysiloxane, an aminosilane, an aminosiloxane, a carboxysilane, a carboxysiloxane, an alkylamidosilane, an alkylamidosiloxane, an arylamidosilane, an arylamidosiloxane, an alkoxyaminosilane, an alkylarylaminosiloxane, an alkoxycarbamatosilane, an alkoxycarbamatosiloxane, an imidatosilane, a ureidosilane, an isocyanatosilane, a isothiocyanatosilane, the condensates thereof and combinations of two or more thereof. Examples of suitable cross-linkers include, but are not limited to, tetraethylorthosilicate (TEOS); methyltrimethoxysilane (MTMS); methyltriethoxysilane; a polycondensate of TEOS, methyltrimethoxysilane (MTMS); a polycondensate of MTMS, vinyltrimethoxysilane; vinyltriethoxysilane; methylphenyldimethoxysilane; 3,3,3-trifluoropropyltrimethoxysilane; methyltriacetoxysilane; vinyltriacetoxysilane; ethyltriacetoxysilane; di-butoxydiacetoxysilane; phenyltripropionoxysilane; methyltris(methylethylketoximo)silane; vinyltris(methylethylketoximo)silane; 3,3,3-trifluoropropyltris(methylethylketoximo)silane; methyltris(isopropenoxy)silane; vinyltris(isopropenoxy)silane; ethylpolysilicate; dimethyltetraacetoxydisiloxane; tetra-n-propylorthosilicate; methyldimethoxy(ethylmethylketoximo)silane; methylmethoxybis(ethylmethylketoximo)silane; methyldimethoxy(acetaldoximo)silane; methyldimethoxy(N-methylcarbamato)silane; ethyldimethoxy(N-methylcarbamato)silane; methyldimethoxyisopropenoxysilane; trimethoxyisopropenoxysilane; methyltriisopropenoxysilane; methyldimethoxy(but-2-en-2-oxy)silane; methyldimethoxy(1-phenylethenoxy)silane; methyldimethoxy-2-(1-carboethoxypropenoxy)silane; methylmethoxydi(N-methylamino)silane; vinyldimethoxy(methylamino)silane; tetra-N,N-diethylaminosilane; methyldimethoxy(methylamino)silane; methyltri(cyclohexylamino)silane; methyldimethoxy(ethylamino)silane; dimethyldi(N,N-dimethylamino)silane; methyldimethoxy(isopropylamino)silane; dimethyldi(N,N-diethylamino)silane; ethyldimethoxy(N-ethylpropionamido)silane; methyldimethoxy(N-methylacetamido)silane; methyltris(N-methylacetamido)silane; ethyldimethoxy(N-methylacetamido)silane; methyltris(N-methylbenzamido)silane; methylmethoxybis(N-methylacetamido)silane; methyldimethoxy(caprolactamo)silane; trimethoxy(N-methylacetamido)silane; methyldimethoxy(ethylacetimidato)silane; methyldimethoxy(propylacetimidato)silane; methyldimethoxy(N,N′,N′-trimethylureido)silane; methyldimethoxy(N-allyl-N′,N′-dimethylureido)silane; methyldimethoxy(N-phenyl-N′,N′-dimethylureido)silane; methyldimethoxyisocyanatosilane; dimethoxydiisocyanatosilane; methyldimethoxyisothiocyanatosilane; methylmethoxydiisothiocyanatosilane, the condensates thereof, or combinations of two or more thereof.

In one embodiment, the crosslinker may be present in an amount from about 1 to about 10 wt. % of the composition or from about 0.1 to about 10 pt. wt. per 100 pt. wt. of the polymer component (A). In another embodiment, the crosslinker may be present in an amount from about 0.1 to about 5 pt. wt. per 100 pt. wt. of the polymer component (A). In still another embodiment, the crosslinker may be present in an amount from about 0.5 to about 3 pt. wt. per 100 pt. wt. of the polymer component (A). Here as elsewhere in the specification and claims, numerical values may be combined to form new or undisclosed ranges.

Additional alkoxysilanes in an amount greater than 0.1 wt. % of component (A) that are not consumed by the reaction between the prepolymer Z′—X—Z′ and which comprise additional functional groups selected from R⁵ can also work as an adhesion promoter and are defined and counted under adhesion promoter component (D) and/or an auxiliary component (H).

In one embodiment, the condensation accelerator (C) comprises an amide compound. The inventors have found that amide compounds can accelerate the curing of compositions comprising compounds with a reactive silyl group. The amide compounds can, in one embodiment, even be considered a catalyst in such compositions.

In one embodiment, the condensation cure accelerator (C) comprises an amide compound of the Formula (6):

R¹⁷ₙJ(O)ₓNR¹⁸R¹⁹ (6)

wherein J is chosen from carbon, phosphorous, and sulfur; x is 1 when J is carbon or phosphorous; x is 2 when J is sulfur; and R¹⁷, R¹⁸, and R¹⁹ are independently chosen from an alkyl, a substituted alkyl, an alkenyl, a substituted alkenyl, an alkynyl, a substituted alyknyl, a carbocycle, a heterocycle, an aryl, or a heteroaryl, substituted organosilane or substituted organosiloxane, polymer or oligomer of R¹⁷, R¹⁸, and R¹⁹.

In one embodiment, R¹⁷, R¹⁸, and R¹⁹ are independently chosen from substituted or unsubstituted, branched or straight chain C₁-C₃₀ alkyl; substituted or unsubstituted, branched or straight chain C₂-C₁₈ alkenyl; substituted or unsubstituted, branched or straight chain C₂-C₁₈ alkynyl; (OCH₂CH₂)₁₋₁₅OH; (OC₃H₆)₁₋₁₅OH; substituted or unsubstituted, saturated or unsaturated, carbocycles or heterocycles; or substituted or unsubstituted aryl or heteroaryl. In one embodiment, R¹⁷, R¹⁸, and R¹⁹ are substituted or unsubstituted, branched or straight chain C₁-C₉ alkyl; substituted or unsubstituted, branched or straight chain C₂-C₉ alkenyl; substituted or unsubstituted, branched or straight chain C₂-C₉ alkynyl; —(OCH₂CH₂)₁₋₇R; (OC₃H₆)₁₋₇—R; substituted or unsubstituted, branched or straight chain C₁-C₅ alkyl; substituted or unsubstituted, branched or straight chain C₂-C₅ alkenyl; substituted or unsubstituted, branched or straight chain C₂-C₅ alkynyl; substituted or unsubstituted, saturated or unsaturated, carbocycles or heterocycles; or substituted or unsubstituted aryl or heteroaryl.

In one embodiment, R¹⁷, R¹⁸, and R¹⁹ are independently chosen from substituted or unsubstituted, branched or straight chain C₁-C₅ alkyl; substituted or unsubstituted, branched or straight chain C₂-C₅ alkenyl; substituted or unsubstituted, branched or straight chain C₂-C₅ alkynyl; substituted or unsubstituted, saturated or unsaturated, carbocycle or heterocycle selected from cyclopropyl, cyclobutyl, cyclopentyl, cyclohexyl, pyrrolidinyl, piperidyl, imidazolidinyl, pyrazolidinyl, pyrazolinyl, piperazinyl, morpholinyl, chromanyl, indolinyl, and the like, including their corresponding iso-forms; or a substituted or unsubstituted fused or unfused aryl or heteroaryl selected from phenyl, benzyl, naphthyl, furyl, benzofuranyl, pyranyl, pyrazinyl, thienyl, pyrrolyl, imidazolyl, pyridyl, pyrimidinyl, pyridazinyl, indolyl, indolizinyl, indoazolyl, purinyl, quinolyl, thiazolyl, phthalazinyl, quinoxalinyl, quinazolinyl, benzothienyl, anthryl, phenathtryl, and the like, including their corresponding iso-forms.

In one embodiment, R¹⁷, R¹⁸, and R¹⁹ are independently chosen from are methyl, ethyl, propyl, isopropyl, butyl, isobutyl, tert-butyl, 2-ethyl-hexyl, cyclopentyl, cyclohexyl, phenyl, pyridinyl, or pyrrolidinyl.

The R¹⁷, R¹⁸, and R¹⁹ groups just discussed contemplate that the alkyl, alkenyl, alkynyl, carbocycles, and heterocycles may themselves be unsubstituted or substituted. The alkyl, alkene, and alkyne groups, as indicated, may be straight chains or branched structures. For unsaturated moieties, e.g. alkenes, alkynes, unsaturated carbocycles, or unsaturated heterocycles, the degree of unsaturation may vary from one unsaturation to the maximum possible within the particular moiety. Unsaturated groups may also have a mixture of double and triple bonds.

In one embodiment, R¹⁸ is hydrogen, R¹⁹ is a C₁-C₁₀ straight chain or branched alkyl group, and R¹⁷ is a C₁₀-C₃₀ straight chain or branched alkyl group.

The amides can be prepared by any suitable process or reaction. In one embodiment, the amide is prepared by reacting an amine with an appropriate acid (e.g., an amide reacted with a carboxylic acid, sulfonic acid, phosphoric acid, etc.). In one embodiment, the amide can be made in situ by mixing a suitable acid and amine along with other components prior to the formulation of the composition and heating them at a temperature of from about 30° C. to about 90° C. or by mixing the amine and acid at a temperature of from about 30° C. to about 90° C. and mixing with the other components.

In one embodiment, the condensation cure accelerator (C) can be added to the curable composition such that the amide compound is present or added in an amount of from about 0.0001 to about 10 pt. wt. related to 100 part per weight of component (A); from about 0.001 to about 7 pt. wt. per 100 pt. wt. of component (A); from about 0.01 to about 5 pt. wt. per 100 pt. wt. of component (A); from about 0.1 to about 2.5 pt. wt. per 100 pt. wt. of component (A). In still another embodiment, the amide compound can be added to the curable composition in an amount of from about 0.005 to about 7.0 pt. wt.; 0.01 to about 7.0 pt. wt.; about 0.05 to about 5 pt. wt.; from about 0.1 to 2.5 pt. wt.; from about 0.5 to about 2 pt. wt.; even from about 1 to about 1.5 pt. wt. per 100 pt. wt. of the polymer (A). In another embodiment, the amide compound is present in an amount of from about 0.005 to about 0.05 pt. wt. per 100 pt. wt. of component (A). Here, as elsewhere in the specification and claims, numerical values can be combined to form new and non-disclosed ranges. An increase in the amount of amide compound as an accelerator may increase the cure rate of curing the surface and decrease the cure time for a tack-free surface and the complete cure through the bulk.

The composition further includes an adhesion promoter component (D) that is different from component (A) or (B). In one embodiment, the adhesion promoter (D) may be an organofunctional silane comprising the group R⁵, e.g., aminosilanes, and other silanes that are not identical to the silanes of component (B), or are present in an amount that exceeds the amount of silanes necessary for endcapping the polymer (A). The amount of non-reacted silane (B) or (D) in the reaction for making (A) can be defined in that after the endcapping reaction the free silanes are evaporated at a higher temperature up to 200° C. and vacuum up to 1 mbar to be more than 0.1 wt. % of (A).

Thus, some selected amines can advantageously be added to fine tune the rate of the metal-complex-catalyzed condensation curing of silicone/non-silicone polymer containing reactive silyl groups, as desired.

In one embodiment, the composition comprises an adhesion promoter (D) comprising a group R⁵ as described by the general formula (7):

R⁵_{g}R¹_{d}Si(R²)_{4-d-g} (7)

wherein R⁵ is E-(CR³₂)ₕ—W—(CH₂)ₕ—; R¹, R², and d are as described above; g is 1 or 2; d+g=1 to 2; and p is 0 to 8, and may be identical or different.

Non-limiting examples of suitable compounds include:

E¹-(CR³₂)ₚ—W—(CH₂)ₚ—SiR₁^{d}(R²)_{3-d} (7a) or (7d)

E²-[(CR³₂)ₚ—W—(CH₂)ₚ—SiR₁^{d}(R²)_{3-d}]ⱼ (7b) or (7f)

wherein j is 2 to 3.

The group E may be selected from either a group E¹ or E². E¹ may be selected from a monovalent group comprising amine, —NH₂, —NHR, —(NHC₂H₅)ₐNHR, NHC₆H₅, halogen, pseudohalogen, unsaturated aliphatic group with up to 14 carbon atoms, epoxy-group-containing aliphatic group with up to 14 carbon atoms, cyanurate-containing group, and an isocyanurate-containing group. E² may be selected from a group comprising of a di- or multivalent group consisting of amine and polyamine. The group W may be selected from either a group W¹ or W². W¹ may be selected from the group consisting of a single bond, —CR₂—, a heteroatomic group selected from —O—, —NR—, —S—, —S—S—, —S—S—S—S—, —SiR₂—, —C(O)—, —C(O)O—, —C(O)NR—, —O—C(O)—O—, —O—C(O)—NR—, —NR—C(O)—O—, —RN—CO—NR—, —S—C(S)—O—, —O—C(S)—S—, —NR—C(O)—S—, —S—C(O)—NR—, —S—C(S)—S—, —SO₂—, —S(O)—, —P(O)(R)—, —O—P(O)(OR)—O—, and epoxy units. W² may be selected from the group consisting of a single bond, —CR₂—, a heteroatomic group selected from —O—, —S—, —S—S—, —S—S—S—S—, —SiR₂—, —C(O)—, —C(O)O—, —O—C(O)—O—, —S—C(S)—O—, —O—C(S)—S—, —S—C(S)—S—, —SO₂—, —S(O)—, —P(O)(R)—, —O—P(O)(OR)—O—, and epoxy units. R⁵ may be selected from hydrogen and R as defined above. R¹ may be identical or different as defined above. R³ may be selected from a C₁-C₈-alkyl, such as methyl, ethyl, a C₃-C₁₂-alkoxyalkyl, a C₂-C₂₂-alkylcarboxy, and a C₄-C₁₀₀-polyalkylene oxide, which may be identical or different.

Non-limiting examples of adhesion promoter component (D) include:

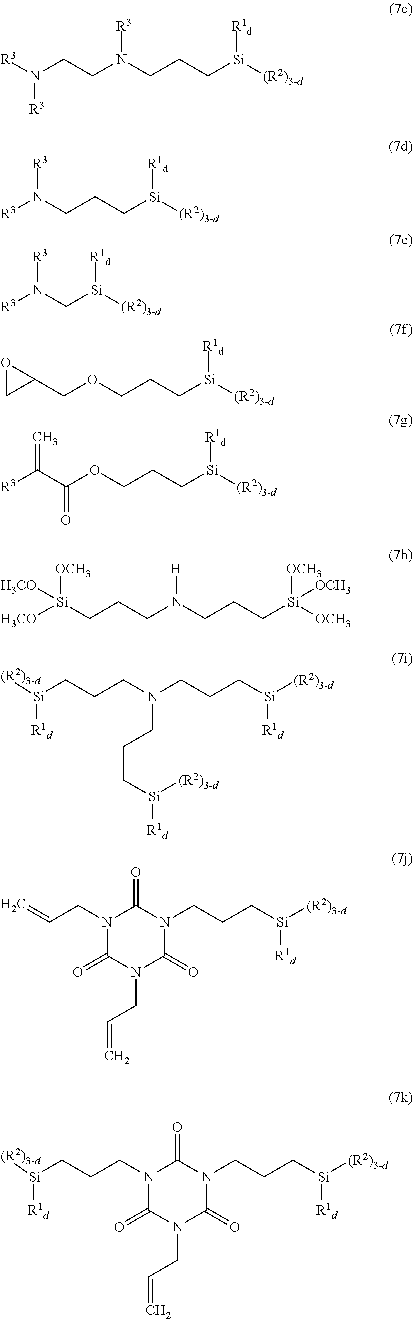

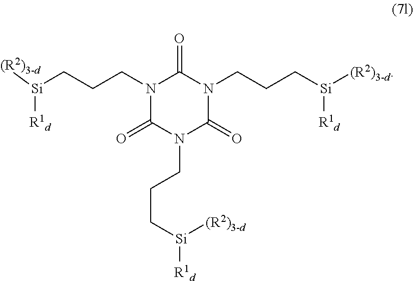

wherein R¹, R², and d are as defined above. Examples of adhesion promoter component (D) include compounds of the formulas (7a-7l). Furthermore the formula (7b) of compounds (D) shall comprise compounds of the formula (7m):

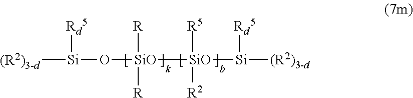

wherein: R, R², R⁵, and d are as defined above; k is 0 to 6 (and in one embodiment desirably 0); b is as described above (in one embodiment desirably 0 to 5); and 1+b≦10. In one embodiment, R⁵ is selected from:

E¹-(CR³₂)ₕ—W—(CH₂)ₕ—

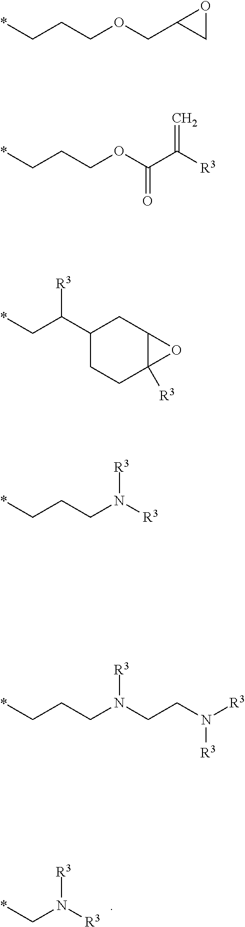

An exemplary group of adhesion promoters are selected from the group that consists of amino-group-containing silane coupling agents. The amino-group-containing silane adhesion promoter agent (D) is an acidic compound having a group containing a silicon atom bonded to a hydrolyzable group (hereinafter referred to as a hydrolyzable group attached to the silicon atom) and an amino group. Specific examples thereof include the same silyl groups with hydrolyzable groups described above. Among these groups, the methoxy group and ethoxy group are particularly suitable. The number of the hydrolyzable groups may be 2 or more, and particularly suitable are compounds having 3 or more hydrolyzable groups.

Examples of other suitable adhesion promoter (D) include, but are not limited to N-(2-aminoethyl)aminopropyltrimethoxysilane, gamma-aminopropyltriethoxysilane, gamma-aminopropyltrimethoxysilane, bis(3-trimethoxysilypropyl)amine, N-phenyl-gamma-aminopropyltrimethoxysilane, triaminofunctionaltrimethoxysilane, gamma-aminopropylmethyldimethoxysilane, gamma-aminopropylmethyldiethoxysilane, methacryloxypropyltrimethoxysilane, methylaminopropyltrimethoxysilane, gamma-glycidoxypropylethyldimethoxysilane, gamma-glycidoxypropyltrimethoxysilane, gamma-glycidoxyethyltrimethoxysilane, gamma-glycidoxypropylmethyldimethoxysilane, gamma-glycidoxypropylmethyldiethoxysilane, beta-(3,4-epoxycyclohexyl)ethyltrimethoxysilane, beta-(3,4-epoxycyclohexyl)ethylmethyldimethoxysilane, beta-(3,4-epoxycyclohexyl)ethyltriethoxysilane, beta-(3,4-epoxycyclohexyl)ethylmethyldiethoxysilane, epoxylimonyltrimethoxysilane, isocyanatopropyltriethoxysilane, isocyanatopropyltrimethoxysilane, isocyanatopropylmethyldimethoxysilane, beta-cyanoethyltrimethoxysilane, gamma-acryloxypropyltrimethoxysilane, gamma-methacryloxypropylmethyldimethoxysilane, alpha, omega-bis(aminoalkyldiethoxysilyl)polydimethylsiloxanes (Pn=1-7), alpha, omega-bis(aminoalkyldiethoxysilyl)octamethyltetrasiloxane, 4-amino-3,3-dimethylbutyltrimethoxysilane, and N-ethyl-3-trimethoxysilyl-2-methylpropanamine, 3-(N,N-diethylaminopropyl)trimethoxysilane combinations of two or more thereof, and the like. Particularly suitable adhesion promoters include bis(alkyltrialkoxysilyl)amines and tris(alkyltrialkoxysilyl)amines including, but not limited to, bis(3-trimethoxysilylpropyl)amine and tris(3-trimethoxysilylpropyl)amine.

Also it is possible to use derivatives obtained by modifying them, for example, amino-modified silyl polymer, silylated amino polymer, unsaturated aminosilane complex, phenylamino long-chain alkyl silane and aminosilylated silicone. These amino-group-containing silane coupling agents may be used alone, or two or more kinds of them may be used in combination.

Also it is possible to use adhesion promoter component different from the nitrogen-containing adhesion promoter component described above. Such other adhesion promoters may include those described by formulas (7), (7a), and (7b) as previously described where E may be E¹ or E². In these other adhesion promoters, E¹ may be selected from halogen, pseudohalogen, unsaturated aliphatic group with up to 14 carbon atoms, and an epoxy-group-containing aliphatic group with up to 14 carbon atoms. E² may be selected from a group comprising of a di- or multivalent group consisting of sulfide, sulfate, phosphate, phosphite and a polyorganosiloxane group, which can contain R⁴ and OR3 groups. For the adhesion promoter component, which does not include a nitrogen, the group W, as described above, is selected from group W². Examples of suitable adhesion promoters include methacryloxypropyltrimethoxysilane, methacryloxypropyltriethoxysilane, glycidoxypropylethyldimethoxysilane, glycidoxypropylethyldiethoxysilane, glycidoxypropylmethyldimethoxysilane, glycidoxypropylmethyldiethoxysilane, glycidoxypropyltrimethoxysilane, glycidoxypropyltriethoxysilane, glycidoxyethyltrimethoxysilane, beta-(3,4-epoxycyclohexyl)ethyltrimethoxysilane, beta-(3,4-epoxycyclohexyl)ethylmethyldimethoxysilane, beta-(3,4-epoxycyclohexyl)ethyltriethoxysilane, beta-(3,4-epoxycyclohexyl)ethylmethyldiethoxysilane, epoxylimonyltrimethoxysilane, epoxylimonyltriethoxysilane, gamma-acryloxypropyltrimethoxysilane, gamma-methacryloxypropylmethyldimethoxysilane, or a combination of two or more thereof.

The adhesion promoter (D) may be present in an amount of from about 0.1 to about 15.0 wt. % based on 100 parts of the polymer component (A). In one embodiment, the adhesion promoter may be present in an amount of from about 0.15 to about 2.0 wt. % based on 100 parts of the polymer component (A). In another embodiment, the adhesion promoter may be present in an amount of from about 0.5 to about 1.5 wt. % of the polymer component (A). This defines the amount of (D) in composition of (A) wherein the content of free silanes coming from the endcapping of polymer (A) is smaller than 0.1 wt. %.

The present compositions may further include a filler component (E). The filler component(s) (E) may have different functions, such as to be used as reinforcing or semi-reinforcing filler, i.e., to achieve higher tensile strength after curing. The filler component may also have the ability to increase viscosity, establish pseudoplasticity/shear thinning, and demonstrate thixotropic behavior. Non-reinforcing fillers may act as volume extenders. The reinforcing fillers are characterized by having a specific surface area of more than 50 m²/g related BET-surface, whereby the semi-reinforcing fillers have a specific surface area in the range of 10-50 m²/g. So-called extending fillers have preferably a specific surface area of less than 10 m²/g according to the BET-method and an average particle diameter below 100 μm. In one embodiment, the semi-reinforcing filler is a calcium carbonate filler, a silica filler, or a mixture thereof. Examples of suitable reinforcing fillers include, but are not limited to, fumed silicas or precipitated silicas, which can be partially or completely treated with organosilanes or siloxanes to make them less hydrophilic and decrease the water content or control the viscosity and storage stability of the composition. These fillers are named hydrophobic fillers. Tradenames are Aerosil®, HDK®, Cab-O-Sil®, etc.

Examples of suitable extending fillers include, but are not limited to, ground silicas (Celite™), precipitated and colloidal calcium carbonates (which are optionally treated with compounds such as stearate or stearic acid); reinforcing silicas such as fumed silicas, precipitated silicas, silica gels and hydrophobized silicas and silica gels; crushed and ground quartz, cristobalite, alumina, aluminum hydroxide, titanium dioxide, zinc oxide, diatomaceous earth, iron oxide, carbon black, powdered thermoplastics such as acrylonitrile, polyethylene, polypropylene, polytetrafluoroethylene and graphite or clays such as kaolin, bentonite or montmorillonite (treated/untreated), and the like.

The type and amount of filler added depends upon the desired physical properties for the cured silicone/non-silicone composition. As such, the filler may be a single species or a mixture of two or more species. The extending fillers can be present from about 0 to about 300 wt. % of the composition related to 100 parts of component (A). The reinforcing fillers can be present from about 5 to about 60 wt. % of the composition related to 100 parts of component (A), preferably 5 to 30 wt. %.

The compositions optionally comprise a cure modifier (F), which, in conjunction with the adhesion promoter and amide accelerator, may accelerate curing (as compared to curing in the absence of such compounds). The cure rate modifying component (F) may be present in an amount of from about 0.01 to about 5 wt. % of the composition. In another embodiment 0.01 to about 8 pt. wt. per 100 pt. wt. of component (A) are used, more preferably 0.02 to 3 pt. wt. per 100 pt. wt. of component (A) and most preferably 0.02 to 1 pt. wt. per 100 pt. wt. of component (A) are used.

The component (F) may be chosen from a variety of materials including acidic compounds such as, but not limited to, various phosphate esters; phosphonates; phosphites; phosphonites; sulfites; sulfates; pseudohalogenides; carboxylic acids including but not limited to acetic acid, lauric acid, stearic acid, and versatic acid; alkyl- and arylsulfonic acids including, but not limited to, p-toluenesulfonic acid and methanesulfonic acid; inorganic acids including, but not limited to, hydrochloric acid, phosphoric acid, and boric acid; amines including, but not limited to, trioctylamine; guanidines including but not limited to tetramethylguanidine; amidines including, but not limited to, 1,8-diazabicyclo[5.4.0]-7-undecene (DBU) and 1,5-diazabicyclo[4.3.0]non-5-ene (DBN); and inorganic bases including, but not limited to, lithium hydroxide and sodium methoxide; or combinations of two or more thereof, and the like. Without being bound to any particular theory, the components (F) may, in one embodiment, be useful as stabilizers in order to ensure a longer storage time when sealed in a cartridge before use in contact with ambient air. For example, alkoxy-terminated polysiloxanes can lose the ability to cure after storage in a cartridge and show decreased hardness under curing conditions. It may, therefore be useful to add compounds of the formula (8), which can extend storage time or ability to cure over months.

O═P(OR²⁰)_{3-c}(OH)_{c} (8)

whereby c is as defined above; and R²⁰ is selected from the group of linear or branched and optionally substituted C₁-C₃₀ alkyl groups, linear or branched C₅-C₁₄ cycloalkyl groups, C₆-C₁₄ aryl groups, C₆-C₃₁ alkylaryl groups, linear or branched C₂-C₃₀ alkenyl groups or linear or branched C₁-C₃₀ alkoxyalkyl groups, C₄-C₃₀₀ polyalkenylene oxide groups (polyethers), such as Marlophor® N5 acid, triorganylsilyl- and diorganyl (C₁-C₉)-alkoxysilyl groups. The phosphates can include also mixtures of primary and secondary esters. Non-limiting examples of suitable phosphonates include 1-hydroxyethane-(1,1-diphosphonic acid) (HEDP), aminotris(methylene phosphonic acid) (ATMP), diethylenetriaminepenta(methylene phosphonic acid) (DTPMP), 1,2-diaminoethane-tetra(methylene phosphonic acid) (EDTMP), and phosphonobutanetricarboxylic acid (PBTC).

In another embodiment, a compound of the formula O═P(OR²¹)_{3-g}(OH)_{g} may be present or added where g is 1 or 2, and R²¹ is defined as R²⁰ or di- or mulitvalent hydrocarbons with one or more amino group.

Another type are phosphonic acid compounds of the formula R⁶P(O)(OH)₂ such as alkyl phosphonic acids preferably hexyl or octyl phosphonic acid.

In one embodiment, the acidic compound may be chosen from a mono ester of phosphoric acid of the formula (R²²O)PO(OH)₂; a phosphonic acid of the formula R²²P(O)(OH)₂; or a monoester of phosphorous acid of the formula (R⁸O)P(OH)₂ where R²² is a C₁-C₁₈ alkyl, a C₂-C₂₀ alkoxyalkyl, phenyl, a C₇-C₁₂ alkylaryl, a C₂-C₄ polyalkylene oxide ester or its mixtures with diesters, etc.

In another embodiment, component (F) is an acidic compound such as a branched C₄-C₃₀ alkyl carboxylic acids, including C₅-C₁₉ acids with an alpha tertiary carbon, or a combination of two or more thereof. Examples of such suitable compounds include, but are not limited to, Versatic™ Acid, lauric acid, and stearic acid. In one embodiment, the acidic compound may be a mixture comprising branched alkyl carboxylic acids. In one embodiment, the acidic compound is a mixture of mainly tertiary aliphatic C₁₀ carboxylic acids.

Generally, the cure rate modifying component (F) is added in a molar ratio of less than or equal to 1 with respect to accelerator (C). In embodiments, the cure rate modifying component (F) is added in a molar ratio of (F):(C) of 1:15 to 1:1.

In one embodiment, the composition can further include (G) an organo-functional silicon compound, a low-molecular-weight organic polymer, a high-boiling-point solvent, or a combination of two or more thereof. Organo-functional silicon compounds include, but are not limited to, an organo-functional silane and/or an organo-functional siloxane. It has been found that the use of organo-functional silanes, organo-functional siloxanes, and/or low-molecular-weight organic polymers with the carboxylic acid catalyst component can enhance the properties of the composition. The compositions still exhibit good curability and adhesion as well as retaining stability under storage and not exhibiting phase separation.

The low-molecular-weight organic polymers, high-boiling-point solvents, and organo-functional silicon compounds may also be referred to herein as extenders.

Low-molecular-weight organic polymers suitable as the extender include compounds or materials having a boiling point greater than 150° C.; in one embodiment from 150° C. to 450° C. Examples of suitable low-molecular-weight compounds as the extender include, but are not limited to, polyether polyols containing repeating ether linkage —R—O—R— and have two or more hydroxyl groups as terminal functional groups, or combinations of two or more thereof. In one embodiment, polyethylene glycol can be employed as an extender.

High-boiling molecules suitable as extenders include high-boiling-point solvents having a boiling point of at least 150° C. For example, a boiling point between 150° C. and 450° C., between 225° C. and 375° C., even between 275° C. and 325° C. Examples of high-boiling-point solvents as extenders include, but are not limited to DMF, DMSO, carbitols or combinations of two or more thereof.

The organo-functional silicon compound can be chosen from a variety of compounds, including, but not limited to, carboxylic acid, ester, polyether, amide, amine, alkyl, aryl, aromatic-grafted or -endcapped siloxanes, organic polymers, or a combination of two or more thereof. For example, the organo-functional silicon can be an alkyl-stopped siloxane such as, for example, methyl-stopped PDMS. The organo-functional silicon compounds can be referred to as organosilicon compounds. The organosilicon compounds can be linear or branched. Examples of suitable organo-functional silicon compounds include, but are not limited to, hydrido-functional siloxanes, vinyl-functional siloxanes, hydroxyl-functional siloxanes, and amino-functional siloxanes. In one embodiment, the extender is an organo-functional polydimethylsiloxane compound such as, for example, hydride-terminated polydimethylsiloxane, silanol-terminated polydimethylsiloxane, vinyl-terminated polydimethylsiloxane, or amino-terminated polydimethylsiloxane.

In one embodiment, the composition comprises an organo-functional siloxane of the formula:

MDₕD′ₖT_{z}T′ⱼM

wherein M represents R⁶₃SiO_{1/2}; D is R⁷₂SiO_{2/2}; D′ is R⁸₂SiO_{2/2}, T is R⁹SiO_{3/2}; T′ is R¹⁰SiO_{3/2}; R⁶, R⁷, R⁸, R⁹, and R¹⁰ are independently chosen from a hydrogen and a monovalent organic group, such as an alkyl group, a heteroalkyl group, an alkenyl group, a heteroalkenyl group, a cycloalkyl group, a heterocycloalkyl, an aryl group, a heteroaryl group, an aryloxy group, an aralkyl group, a heteroaralkyl group, an alkylaryl group, a heteroalkylaryl group, an epoxy group, an amino group, a mercapto group, a trifluoropropyl group, a polyalkylene oxide group, a silicon-containing alkyl group, a silicon-containing aryl group, an alkyl, aryl, alkylaryl, or aralkyl bridge formed by at least two R⁶, two R⁷, or two R⁸ groups. The values of h, k, z, and j may vary greatly depending upon the desired end viscosity of the polymers of the present invention. In one embodiment, the viscosity of the organo-functional silicon compound is between the range of about 1 centiStokes (cSt) at 25° C. to about 2,000,000 centiStokes (cSt) at 25° C. In another embodiment, the viscosity of the organo-functional silicon compound is between the range of about 1 cSt at 25° C. to about 200,000 cSt at 25° C. In yet another embodiment, the viscosity of the organo-functional silicon compound is between the range of about 1 cSt at 25° C. to about 10,000 cSt at 25° C. In yet another embodiment, the viscosity of the organo-functional silicon compound is between the range of about 1 cSt at 25° C. to about 3,000 cSt at 25° C. Here as elsewhere in the specification and claims, numerical values can be combined to form new and non-disclosed ranges. The organo-functional silicon compound comprises at least one organic group. In one embodiment, R⁶, R⁷, and R⁸ are independently chosen from a C1-C13 alkyl group, a C1-C13 alkoxygroup, a C2-C13 alkenyl group, a C2-C13 alkenyloxy group, a C3-C6 cycloalkyl group, a C3-C6 cycloalkoxy group, a C6-C14 aryl group, a C6-C10 aryloxy group, a C7-C13 aralkyl group, a C7-C13 aralkoxy group, a C7-C13 alkylaryl group, a C7-C13 alkylaryloxy group, and a C2-C8 ether group. In one embodiment, at least one of R⁶, R⁷, R⁸, R⁹, and/or R¹⁹ group is a hydrogen.

In one embodiment, the organo-functional siloxane compound comprises an alkoxy group, an alkylaryl group, an ether group, or a combination of two or more thereof. Examples of suitable alkoxy groups include, but are not limited to, methoxy, ethoxy, propoxy, isopropoxy, butoxy, isobutoxy, etc. Examples of suitable alkylaryl groups include, but are not limited to, alkyl phenols. Examples of suitable ether groups include alkyl ethers such as, but not limited to, methyl ether groups, ethyl ether groups, propyl ether groups, butyl ether groups, etc., and combinations of two or more thereof.

In one embodiment, the organo-functional siloxane can be of the formula:

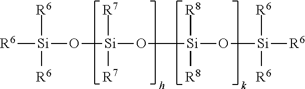

wherein R⁶, R⁷, R⁸, h, and k are described above. In one embodiment, the viscosity of the organo-functional silicon compound is from about 1 cSt at 25° C. to about 2,000 cSt at 25° C. In one embodiment, at least one of R⁶ is chosen from an alkyl, an aryl, an alkoxy, an ether group, or combinations of two or more thereof.

In one embodiment, the organo-functional silicon compound is of the formula:

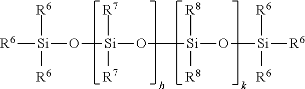

wherein h and k are described above and at least one R⁶, R⁷, or R⁸ is chosen from a group of the formula:

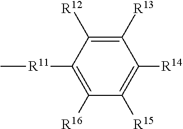

where R¹¹ is a bond or a divalent hydrocarbon and R¹², R¹³, R¹⁴, R¹⁵, and R¹⁶ are independently chosen from hydrogen, a hydroxy, an alkyl, a heteroalkyl, an alkoxy, an alkenyl, a heteroalkenyl, an alkenyloxy, a cycloalkyl, a heterocycloalkyl, a cycloalkoxy, an aryl, a heteroaryl, an aryloxy, an aralkyl, a heteroaralkyl, an alkylaryl, a heteroalkylaryl, an alkylaryloxy, an alkyl, aralkyl, alkylalkoxy, dialkoxy, heteroalkyl, heteroaryl, heteroaralkyl, or heteroalkylaryl bridge formed by one or more of R¹²-R¹³, R¹³-R¹⁴, R¹⁴-R¹⁵, and R¹⁵-R¹⁶, or a combination of two or more thereof. In one embodiment, the organo-functional siloxane is alkyl-stopped. In one embodiment, the organo-functional siloxane is methyl-stopped. In one embodiment, the organo-functional siloxane is of the formula:

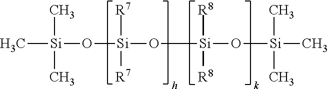

wherein R⁷, R⁸, h, and k are described above. In one embodiment, the organo-functional siloxane is of the formula:

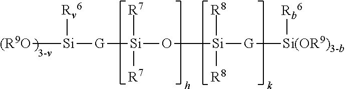

wherein v=0 or 1, b=0 or 1, G represents an oxygen atom or an unsubstituted bivalent hydrocarbon group, and R⁶, R⁷, R⁸, R⁹, h, and k are described above.

In one embodiment, the organo-functional siloxane comprises an alkylaryl group such as, for example an alkyl phenol group. In one embodiment, the organo-functional siloxane is of the formula:

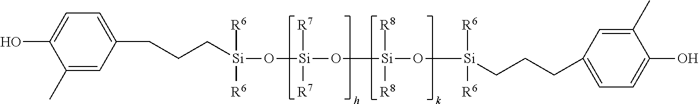

wherein R⁶, R⁷, R⁸, h, and k are described above.

In one embodiment, the organo-functional silicon compound is an organosilicon compound having hydrolyzable groups. Examples of suitable hydrolyzable groups include, but are not limited to an alkoxy group, an alkoxyalkoxy group, or a combination of two or more thereof. Non-limiting examples of suitable hydrolyzable groups include methoxy, ethoxy, propoxy, isopropoxy, butoxy, methoxyethoxy, etc., and combinations of two or more thereof. Still further examples of suitable organosilicon compounds include, but are not limited to, tetraethoxysilane, tetramethoxysilane, methyltrimethoxysilane, vinyltrimethoxysilane, methyltriethoxysilane, vinyltriethoxysilane, ethylorthosilicate, propylorthosilicate, partial hydrolysates of such compounds, and combinations of two or more thereof.

The curable composition may also include auxiliary components (H) such as plastizers, pigments, stabilizers, anti-microbial agents, fungicides, biocideJ, and/or solvents. Preferred plastizers for reactive polyorganosiloxanes (A) are selected from the group of polyorganosiloxanes having chain lengths of 10 to 300 siloxy units. Preferred are trimethylsilyl terminated polydimethylsiloxanes having a viscosity of 100 to 1000 mPa·s at 25° C. The choice of optional solvents (dispersion media or extenders) may have a role in assuring uniform dispersion of the accelerator, thereby altering curing speed. Such solvents include polar and non-polar solvents such as toluene, hexane, chloroform, methanol, ethanol, isopropyl alcohol, acetone, methylethyl ketone, dimethylformamide (DMF), dimethyl sulfoxide (DMSO), N-methylpyrrolidinone (NMP), and propylene carbonate. Water can be an additional component (G) to accelerate fast curing 2-part compositions RTV-2, whereby the water can be in one part of the 2 compositions. Particularly suitable non-polar solvents include, but are not limited to, toluene, hexane, and the like if the solvents should evaporate after cure and application. In another embodiment, the solvents include high-boiling hydrocarbons such as alkylbenzenes, phtalic acid esters, arylsulfonic acid esters, trialkyl- or triarylphosphate esters, which have a low vapor pressure and can extend the volume providing lower costs. Examples cited by reference may be those of U.S. Pat. No. 6,599,633; U.S. Pat. No. 4,312,801. The solvent can be present in an amount of from about 20 to about 99 wt. % of the accelerator composition.

Applicants have found that using amide compounds as an accelerator may provide a curable composition that yields a cured polymer exhibiting a tack-free time, hardness, and/or cure time comparable to compositions made using tin catalysts, but that provide better adhesion compared to materials made using tin catalysts. Further, the curing properties can be controlled by using the amide compound with one or more adhesion promoters.

In one embodiment, a composition in accordance with the present invention comprises: 100 wt. % polymer component (A); about 0.1 to about 10 wt. % crosslinker component (B); and about 0.01 to about 7 wt. % cure accelerator (C). In one embodiment, the composition further comprises from about 0.1 to about 15, in one embodiment 0.15 to 1 wt. %, of an adhesion promoter component (D); about 0 to about 300 pt. wt. filler component (E); about 0.01 to about 7 wt. % of acidic compound (F); optionally 0 to about 15 wt. % auxiliary component (G), where the wt. % of components (B)-(G) are each based on 100 parts of the polymer component (A). In one embodiment, the composition comprises the cure rate modifying component (F) in an amount of from about 0.001 to about 1 wt. % per 100 pt. wt. of component (A). In still another embodiment, the composition comprises the accelerator (C) in an amount of from about 0.1 to about 0.8 wt. % per 100 wt. % of component (A).

It will be appreciated that the curable compositions may be provided as either a one-part composition or a two-part composition. A one-part composition refers to a composition comprising a mixture of the various components described above. A two-part composition may comprise a first portion and a second portion that are separately stored and subsequently mixed together just prior to application for curing. In one embodiment, a two-part composition comprises a first portion (P1) comprising a polymer component (A) and a crosslinker component (B), and a second portion (P2) comprising the cure accelerator component (C) comprising the amide compound. The first and second portions may include other components (F) and/or (G) and or J as may be desired for a particular purpose or intended use. For example, in one embodiment, the first portion (P1) may optionally comprise an adhesion promoter (D) and/or a filler (E), and the second portion (P2) may optionally comprise the organo-functional silane/siloxane (G), etc., as may be desired for a particular purpose or intended use and auxiliary substances (H), a cure rate modifying component (F), and water.

In one embodiment, a two-part composition comprises (i) a first portion comprising the polymer component (A), optionally the filler component (E), and optionally the acidic compound (F); and (ii) a second portion comprising the crosslinker (B), the accelerator component (C), the adhesive promoter (D), and the acidic compound (F), where portions (i) and (ii) are stored separately until applied for curing by mixing of the components (i) and (ii).

An exemplary two-part composition comprises: a first portion (i) comprising 100 pt. wt. of component (A), and 0 to 70 pt. wt. of component (E); and a second portion (ii) comprising 0.1 to 5 pt. wt. of at least one crosslinker (B); 0.01 to 4 pt. wt. of an accelerator (C); 0.1 to 2 pt. wt. of an adhesion promoter (D); and 0.02 to 1 pt. wt. cure rate modifying component (F).

Another exemplary two-part composition comprises: a first portion (i) comprising 100 pt. wt. of component (A), 0.1 to 5 pt. wt. of at least one crosslinker (B), and 0 to 70 pt. wt. of component (E); and 0.02 to 1 pt. wt. cure rate modifying component (F) and a second portion (ii) comprising; 0.01 to 4 pt. wt. of an accelerator (C); optionally 0.1 to 2 pt. wt. of an adhesion promoter (D); optionally an comprise the organo-functional silane/siloxane (G), and an auxiliary substance (H).

The curable compositions may be used in a wide range of applications including as materials for sealing, mold making, glazing, prototyping; as adhesives; as coatings in sanitary rooms; as joint seal between different materials, e.g., sealants between ceramic or mineral surfaces and thermoplastics; as paper release; as impregnation materials; and the like. A curable composition in accordance with the present invention comprising an amide-containing compound as an accelerator may be suitable for a wide variety of applications such as, for example, a general purpose and industrial sealant, potting compound, caulk, adhesive or coating for construction use, insulated glass, structural glazing, where glass sheets are fixed and sealed in metal frame; caulks, adhesives for metal plates, car bodies, vehicles, electronic devices, and the like. Furthermore, the present composition may be used either as a one-part RTV-1 or as a two-part RTV-2 formulation that can adhere onto broad variety of metal, mineral, ceramic, rubber, or plastic surfaces.

Curable compositions comprising amide compounds as cure accelerators may be further understood with reference to the following Examples.

### EXAMPLES

### Examples 1-16

Examples 1-16 are prepared according to the formulations in Tables 1-4 by adding Component A (silanol-stopped PDMS+silica filler+low molecular weight PDMS) to Component B (cross-liker (e.g., ethylpolysilicate (EPS)), adhesion promoter, and amide cure accelerator) and mixing using a Hauschild mixer for 1.5 min. The mixed formulation is poured into a Teflon mold (length×width×depth about 10 cm×10 cm×1 cm) placed inside a fume hood. The surface curing (TFT) and bulk curing is monitored as a function of time (maximum of 7 days). The comparative examples are prepared without the amide compound.

### Measurement of Surface Curing (TFT) and Bulk Curing

The surface cure is denoted by tack free time (TFT). In a typical TFT measurement, a stainless steel (SS) weight (weighing about 10 g) is placed on the surface of the formulation spread on the Teflon mold to infer the tackiness of the surface as whether any material is adhered to the surface of the SS weight or not. TFT is defined as the time taken for getting a non-tacky surface. Bulk curing is the time taken for complete curing of formulation throughout the thickness (i.e. top to bottom) and it is monitored as a function of time by measuring the Shore A hardness and or visual inspection.

### Measurement of the Storage Stability

For aging studies the pre-mixed mixture containing cross-linker adhesion promoter, and cure accelerator or storage stabilizer are kept in an oven for (1) 4 hours at 50° C., or (2) 5 days at 70° C., after which specified period the mixture is removed from oven and allow it to attain room temperature. The mixture is mixed with Compound A using a Hauschild mixer for 1.5 min. The mixed formulation is poured into a Teflon mold (length×breadth×depth of about 10 cm×10 cm×1 cm) and placed inside a fume hood. The surface curing (TFT) and bulk curing is monitored as a function of time (maximum of 7 days) and ° Shore A hardness in order to determine the complete cure and to what extent the compositions maintain performance after storage under accelerated conditions of cured cake (85% humidity and 85° C. An increased temperature for the storage test should simulate the storage effect at room temperature (25° C., 50% relative humidity) over longer times in a kind of time lapse.

TABLE 1

| | | | | | | | | | |
|---|---|---|---|---|---|---|---|---|---|
| Comp. | | | | | | Comp. | | | |
| Ex. 1 | Ex. 1 | Ex. 2 | Ex. 3 | Ex. 4 | Ex. 5 | Ex. 2 | Ex. 6 | Ex. 7 | Ex. 8 |

Component A

| | | | | | | | | | | |
|---|---|---|---|---|---|---|---|---|---|---|
| OH end capped PDMS 4 Pa · s | 60.3 | 60.3 | 60.3 | 60.3 | 60.3 | 60.3 | 60.3 | 60.3 | 60.3 | 60.3 |
| OH PDMS (3500 cps) | 10 | 10 | 10 | 10 | 10 | 10 | 10 | 10 | 10 | 10 |
| Silica | 29.7 | 29.7 | 29.7 | 29.7 | 29.7 | 29.7 | 29.7 | 29.7 | 29.7 | 29.7 |

Component B

| | | | | | | | | | | |
|---|---|---|---|---|---|---|---|---|---|---|
| Ethyl polysilicate | 1 | 1 | 1 | 1 | 1 | 1 | 1 | 1 | 1 | 1 |
| Bis(3-propyltrimethoxysilyl)amine | 0.6 | 0.6 | | | | | 0.8 | 0.8 | 0.8 | 0.8 |
| N-β-(Aminoethyl)-y-aminopropyl-trimethoxysilane | | | 0.6 | | | | 0.6 | 0.6 | | |
| 3-Aminopropyl-trimethoxysilane (A1110) | | | | 0.6 | | | | | 0.6 | 0.6 |
| 3-(N-ethylamino)-2-methylpropyl-trimethoxy silane | | | | | 0.6 | | | | | |
| Tris(3-(trimethoxysilyl)propyl)isocyanurate | | | | | | 0.6 | | | | |
| Dibutyltin dilaurate (DBTDL) | 0.1 | | | | | | | | | |
| N-(2-ethylhexyl)-7,7-dimethyloctanamide | | 0.1 | 0.1 | 0.1 | 0.1 | 0.1 | 0.1 | 0.05 | 0.2 | 0.4 |
| Tack-free time (min)-Comp B aged 4 hour at 50° C | 11 | 10 | 22 | 23 | 19 | 220 | 32 | 18 | 12 | 6 |
| Shore-A hardness (top/bottom) -(Comp B) after | 68/60 | 68/62 | 50/19 | 46/22 | 62/48 | 52/23 | 50/15 | 52/12 | 53/14 | 60/18 |
| aging at 4 hour at 50° C. (tested after 1 day) | | | | | | | | | | |
| Tack-free time (min) after aging at (Comp B) | NT | 11 | 23 | 14 | 23 | 240 | 38 | 21 | 16 | 11 |
| 70° C for 5 hours | | | | | | | | | | |
| Shore-A hardness (top/bottom) -(Comp B) after | NT | 70/63 | 62/56 | 61/53 | 65/63 | 42/55 | NT | 63/51 | 65/50 | 65/55 |
| aging at 70° C. for 5 days (tested after 3 days) | | | | | | | | | | |

TABLE 2

| | | | |
|---|---|---|---|
| Comp | | | |
| Ex. 3 | Ex. 9 | Ex. 10 | Ex. 11 |

Component A

| | | | | |
|---|---|---|---|---|
| OH-end capped PDMS 4 Pa · s | 80 | 80 | 80 | 80 |
| Silica | 20 | 20 | 20 | 20 |

Component B

| | | | | |
|---|---|---|---|---|
| Ethyl polysilicate | 0.8 | 1 | 1 | 1 |
| N-β (Aminoethyl)-gamma- | 0.8 | 0.6 | 0.7 | 0.7 |
| aminopropyl-trimethoxysilane | | | | |
| Aminosiloxane (SF 1706) | | | 0.3 | 0.3 |
| 3-Aminopropyl-trimethoxysilane | 0.9 | | | |
| Bis(3-propyltrimethoxysilyl)amine | | 0.8 | 0.7 | 0.7 |
| Tris(3- | 0.3 | | 0.3 | 0.3 |
| (trimethoxysilyl)propyl)isocyanurate | | | | |
| (ISO-T) | | | | |
| Dibutyltin dilaurate (DBTDL) | 0.1 | | | |
| N-(2-ethylhexyl)-7,7- | | 0.1 | | 0.1 |
| dimethyloctanamide | | | | |
| N-(2-ethyl)dodecanamide | | | 0.07 | |

Properties- 50° C., 4 hours

| | | | | |
|---|---|---|---|---|
| Tack-free time (min) -after aging | 20 | 17 | 24 | 20 |
| (comp B) at 50° C. for 4 hours | | | | |
| Shore-A hardness (top/bottom)- | 31/20 | 31/24 | 31/15 | 31/17 |
| immediately after curing | | | | |

Adhesion test

| | | | | |
|---|---|---|---|---|
| CU | ◯ | ◯ | ◯ | ◯ |
| Al | ◯ | ◯ | ◯ | ◯ |
| Glass | ◯ | ◯ | ◯ | ◯ |
| Epoxy Glass | ◯ | ◯ | ◯ | ◯ |
| PC | ◯ | ◯ | ◯ | ◯ |
| PVC | ◯ | ◯ | ◯ | ◯ |
| PBT | ◯ | X | ◯ | X |
| ABS | ◯ | X | ◯ | ◯ |
| AC | ◯ | X | ◯ | ◯ |
| Noryl | ◯ | ◯ | ◯ | ◯ |

◯ = good adhesion to surface
X = no adhesion

TABLE 3

| Comp. | Ex. | | |
|---|---|---|---|
| Ex. 4 | 12 | Ex. 13 | Ex. 14 |

Component A

| | | | | |
|---|---|---|---|---|
| OH end capped PDMS 4 Pa · s | 60.3 | 60.3 | 60.3 | 60.3 |
| OH PDMS (3500 cps) | 10 | 10 | 10 | 10 |
| Silica | 29.7 | 29.7 | 29.7 | 29.7 |

Component B

| | | | | |
|---|---|---|---|---|
| Ethyl polysilicate | | 1 | | |
| n-propylsilicate | 3 | | 3 | |
| Methyltrimethoxysilane | | | | 3 |
| Bis(3-propyltrimethoxysilyl)amine | 0.8 | 0.8 | 0.8 | 0.8 |
| N-β (Aminoethyl)-gamma- | 0.6 | 0.6 | 0.6 | 0.6 |
| aminopropyl-trimethoxysilane | | | | |
| Dibutyltin dilaurate (DBTDL) | 0.4 | | | |
| N-(2-ethylhexyl)-7,7- | | 0.4 | 0.4 | 0.4 |
| dimethyloctanamide | | | | |
| Tack-free time (min)-Comp B aged | 25 | 6 | 20 | 25 |
| 4 hour at 50° C. | | | | |
| Tack-free time (min) after aging at | | 12 | 22 | 12 |
| (Comp B) 70° C. for 5 days | | | | |

TABLE 4

| Comp. | | Ex. |
|---|---|---|
| Ex. 6 | Ex. 15 | 16 |

Component A

| | | | |
|---|---|---|---|
| OH end capped PDMS 4 Pa · s | 60.3 | 60.3 | 60.3 |
| OH PDMS (3500 cps) | 10 | 10 | 10 |
| Silica | 29.7 | 29.7 | 29.7 |

Component B

| | | | |
|---|---|---|---|
| Ethyl polysilicate | 1 | 1 | 1 |
| Bis(3-propyltrimethoxysilyl)amine | 0.8 | 0.7 | 0.7 |
| Aminopropyl-trimethoxysilane | 0.6 | 0.7 | 0.7 |
| 3-(N-ethylamino)-2-methylpropyl-trimethoxy | | 0.3 | 0.3 |
| silane | | | |
| Aminosiloxane | | 0.3 | 0.3 |
| Tris(3-(trimethoxysilyl)propyl)isocyanurate | | 0.3 | 0.2 |
| (ISO-T) | | | |
| N-(2-ethylhexyl)-7,7-dimethyloctanamide | | | 0.06 |
| N-(2-ethyl)dodecanamide | | 0.08 | |
| Versatic acid | 0.06 | | |
| Tack-free time (min)-Comp B aged 4 hour | 15 | 24 | 20 |
| at 50° C. | | | |
| Shore-A hardness (top/bottom) -(Comp B) | 36/24 | 31/15 | 31/17 |
| after aging at 4 hour at 50° C. (tested | | | |
| after 1 day) | | | |

Adhesion to PBT, AC, & ABS

| | | | |
|---|---|---|---|
| PBT | X | ◯ | X |
| AC | X | ◯ | ◯ |
| ABS | X | ◯ | ◯ |

◯ = good adhesion to surface
X = no adhesion

The data in Tables 1-4 show that using an amide compound can be a suitable replacement to tin as a cure accelerator or catalyst in condensation curable systems. Examples 4-6 show that using a combination of adhesion promoters with an amide-based compound can improve the curing properties of the composition. By using different levels of amide-based compound and varying the adhesion promoters, the properties of the composition can be tuned or controlled for a particular purpose or intended application.

Embodiments of the invention have been described above and modifications and alterations may occur to others upon the reading and understanding of this specification. The claims as follows are intended to include all modifications and alterations insofar as they come within the scope of the claims or the equivalent thereof.

1. A composition for forming a curable polymer composition comprising:
(A) a polymer having at least a reactive silyl group;
(B) a crosslinker or chain extender;
(C) a condensation accelerator comprising an amide compound;
(D) optionally an adhesion promoter;
(E) optionally, a filler component;
(F) optionally, a cure modifier;
(G) optionally, an organo-functional silicon compound, a low-molecular-weight organic polymer, a high-boiling-point solvent, or a combination of two or more thereof; and
(H) optionally, an auxiliary component.

2. The composition of claim 1, wherein the amide compound is of the formula:
R¹⁷ₙJ(O)ₓNR¹⁸R¹⁹ (7)
wherein J is chosen from carbon, phosphorous, and sulfur; x is 1 when J is carbon or phosphorous; x is 2 when J is sulfur; n is 1 when J is C; n is 2 when J is P, and R¹⁷, R¹⁸, and R¹⁹ are independently chosen from hydrogen, an alkyl, a substituted alkyl, an alkenyl, a substituted alkenyl, an alkynyl, a substituted alkynyl, a carbocycle, a heterocycle, an aryl, a heteroaryl, a substituted organosilane, or a substituted organosiloxane.

3. The composition of claim 2, wherein R¹⁷, R¹⁸, and R¹⁹ are independently chosen from substituted or unsubstituted, branched or straight chain C₁-C₃₀ alkyl; substituted or unsubstituted, branched or straight chain C₂-C₁₈ alkenyl; substituted or unsubstituted, branched or straight chain C₂-C₁₈ alkynyl; —(OCH₂CH₂)₁₋₁₅OH; —(OC₃H₆)₁₋₁₅OH; substituted or unsubstituted, saturated or unsaturated, carbocycles or heterocycles; or substituted or unsubstituted aryl or heteroaryl.

4. The composition of claim 2, wherein J is carbon, and R¹⁷, R¹⁸, and R¹⁹ are independently chosen from substituted or unsubstituted, branched or straight chain C₁-C₃₀ alkyl; substituted or unsubstituted, branched or straight chain C₂-C₁₈ alkenyl; substituted or unsubstituted, branched or straight chain C₂-C₁₈ alkynyl; —(OCH₂CH₂)₁₋₁₅OH; —(OC₃H₆)₁₋₁₅ OH; substituted or unsubstituted, saturated or unsaturated, carbocycles or heterocycles; or substituted or unsubstituted aryl or heteroaryl.

5. The composition of claim 1 comprising from about 0.0001 to about 10 pt. wt. of accelerator (C) per 100 pt. wt. of the polymer (A).

6. The composition of claim 1 comprising from about 0.005 to about 0.05 pt. wt. of accelerator (C) per 100 parts of component.

7. The composition of claim 1, wherein the accelerator (C) is substantially free of tin.

8. The polymer composition of claim 1, wherein the polymer (A) has the formula (1):
[R¹_{c}R²_{3-c}Si—Z—]ₙ—X—Z—SiR¹_{c}R²_{3-c} (1)
wherein X is chosen from a polyurethane; a polyester; a polyether; a polycarbonate; a polyolefin; a polyesterether; and a polyorganosiloxane having units of R₃SiO_{1/2}, R₂SiO, RSiO_{3/2}, and/or SiO₂; n is 0 to 100; c is 0 to 2; R and R¹ can be identical or different at the same Si-atom and chosen from a C₁-C₁₀ alkyl; a C₁-C₁₀ alkyl substituted with one or more of Cl, F, N, O or S; a phenyl; a C₇-C₁₆ alkylaryl; a C₇-C₁₆ arylalkyl; a C₂-C₄ polyalkylene ether; or a combination of two or more thereof; R² is chosen from OH, C₁-C₈ alkoxy, C₂-C₁₈ alkoxyalkyl, oximoalkyl, enoxyalkyl, aminoalkyl, carboxyalkyl, amidoalkyl, amidoaryl, carbamatoalkyl, or a combination of two or more thereof; and Z is a bond, a divalent unit selected from the group of a C₁-C₈ alkylene, or O.

9. The polymer composition of claim 1 wherein the polymer component (A) has the formula (2):
R²_{3-c}R¹_{c}Si—Z—[R₂SiO]ₓ[R¹₂SiO]_{y}—Z—SiR¹_{c}R²_{3-c} (2)
wherein x is 0 to 10,000; y is 0 to 10,000; c is 0 to 2; R is methyl; R¹ is chosen from a C₁-C₁₀ alkyl; a C₁-C₁₀ alkyl substituted with one or more of Cl, F, N, O, or S; a phenyl; a C₇-C₁₆ alkylaryl; a C₇-C₁₆ arylalkyl; a C₂-C₄ polyalkylene ether; or a combination of two or more thereof, and other siloxane units may be present in amounts less than 10 mol. % preferably methyl, vinyl, phenyl; R² is chosen from OH, a C₁-C₈ alkoxy, a C₂-C₁₈ alkoxyalkyl, an oximoalkyl, an oximoaryl, an enoxyalkyl, an enoxyaryl, an aminoalkyl, an aminoaryl, a carboxyalkyl, a carboxyaryl, an amidoalkyl, an amidoaryl, a carbamatoalkyl, a carbamatoaryl, or a combination of two or more thereof; and Z is —O—, a bond, or —C₂H₄—.

10. The composition of claim 1, wherein the polymer (A) is chosen from silylated polyurethane (SPUR), silylated polyester, silylated polyether, silylated polycarbonate, silylated polyolefins like polyethylene, polypropylene, silylated polyesterether and combinations of two or more thereof.

11. The composition of claim 1, wherein the crosslinker (B) is chosen from an alkoxysilane, an alkoxysiloxane, an oximosilane, an oximosiloxane, an enoxysilane, an enoxysiloxane, an aminosilane, an aminosiloxane, a carboxysilane, a carboxysiloxane, an alkylamidosilane, an alkylamidosiloxane, an arylamidosilane, an arylamidosiloxane, an alkoxyaminosilane, an alklarylaminosiloxane, an alkoxycarbamatosilane, an alkoxycarbamatosiloxane, and combinations of two or more thereof.

12. The composition of claim 1, wherein the crosslinker component (B) is chosen from tetraethylorthosilicate (TEOS); methyltrimethoxysilane (MTMS); methyltriethoxysilane; vinyltrimethoxysilane; vinyltriethoxysilane; methylphenyldimethoxysilane; 3,3,3-trifluoropropyltrimethoxysilane; methyltriacetoxysilane; vinyltriacetoxysilane; ethyltriacetoxysilane; di-butoxydiacetoxysilane; phenyltripropionoxysilane; methyltris(methylethylketoximo)silane; vinyltris(methylethylketoximo)silane; 3,3,3-trifluoropropyltris(methylethylketoximo)silane; methyltris(isopropenoxy)silane; vinyltris(isopropenoxy)silane; ethylpolysilicate; dimethyltetraacetoxydisiloxane; tetra-n-propylorthosilicate; methyldimethoxy(ethylmethylketoximo)silane; methylmethoxybis(ethylmethylketoximo)silane; methyldimethoxy(acetaldoximo)silane; methyldimethoxy(N-methylcarbamato)silane; ethyldimethoxy(N-methylcarbamato) silane; methyldimethoxyisopropenoxysilane; trimethoxyisopropenoxysilane; methyltriisopropenoxysilane; methyldimethoxy(but-2-en-2-oxy)silane; methyldimethoxy(1-phenylethenoxy)silane; methyldimethoxy-2-(1-carboethoxypropenoxy)silane; methylmethoxydi(N-methylamino)silane; vinyldimethoxy(methylamino)silane; tetra-N,N-diethylaminosilane; methyldimethoxy(methylamino)silane; methyltri(cyclohexylamino)silane; methyldimethoxy(ethylamino)silane; dimethyldi(N,N-dimethylamino)silane; methyldimethoxy(isopropylamino)silane; dimethyldi(N,N-diethylamino)silane; ethyldimethoxy(N-ethylpropionamido)silane; methyldimethoxy(N-methylacetamido)silane; methyltris(N-methylacetamido)silane; ethyldimethoxy(N-methylacetamido)silane; methyltris(N-methylbenzamido)silane; methylmethoxybis(N-methylacetamido)silane; methyldimethoxy(caprolactamo)silane; trimethoxy(N-methylacetamido)silane; methyldimethoxy(ethylacetimidato)silane; methyldimethoxy(propylacetimidato)silane; methyldimethoxy(N,N′,N′-trimethylureido)silane; methyldimethoxy(N-allyl-N′,N′-dimethylureido)silane; methyldimethoxy(N-phenyl-N′,N′-dimethylureido)silane; methyldimethoxyisocyanatosilane; dimethoxydiisocyanatosilane; methyldimethoxyisothiocyanatosilane; methylmethoxydiisothiocyanatosilane, the condensates thereof, or a combination of two or more thereof.

13. The composition of claim 1 comprising an adhesion promoter component (D).

14. The composition of claim 13, wherein the adhesion promoter is chosen from an (aminoalkyl)trialkoxysilane, an (aminoalkyl)alkyldialkoxysilane, a bis(trialkoxysilylalkyl)amine, a tris(trialkoxysilylalkyl)amine, a tris(trialkoxysilylalkyl)cyanurate, a tris(trialkoxysilylalkyl)isocyanurate, an (epoxyalkyl)alkyldialkoxysilane, an (epoxyalkyl)trialkoxysilane, or a combination of two or more thereof.

15. The composition of claim 1 comprising a filler component (E).

16. The composition of claim 1 comprising at least one component (F) chosen from a phosphate ester, a phosphonate ester, a phosphonic acid, a phosphorous acid, a phosphite, a phosphonite ester, a sulfate, a sulfite, a pseudohalogenide, a carboxylic acid, an alkyl-sulfonic acid, an aryl sulfonic acid, an inorganic acid, an amine, a guanidine, an amidine, an inorganic base, or a combination of two or more thereof.

17. The composition of claim 1, wherein the organo-functional silicon compound is chosen from a compound of formula:
MDₕD′ₖT_{z}T′ⱼM
where M is R⁶₃SiO_{1/2}; D is R⁷₂SiO_{2/2}; D′ is R⁸₂SiO_{2/2}, T is R⁹SiO_{3/2}; T′ is R¹⁰SiO_{3/2}; R⁶, R⁷, R⁸, R⁹, and R¹⁰ are independently chosen from a hydrogen and a monovalent organic group, such as an alkyl group, a heteroalkyl group, an alkenyl group, a heteroalkenyl group, a cycloalkyl group, a heterocycloalkyl, an aryl group, a heteroaryl group, an aryloxy group, an aralkyl group, a heteroaralkyl group, an alkylaryl group, a heteroalkylaryl group, an epoxy group, an amino group, a mercapto group, a polyalkylene oxide group, a silicon-containing alkyl group, a silicon-containing aryl group, an alkyl, aryl, alkylaryl, or aralkyl bridge formed by at least two R⁶, two R⁷, or two R⁸ groups; and h, k, z, and j are chosen such that the viscosity of the organo-functional silicon compound is from about 1 centiStokes (cSt) at 25° C. to about 2,000,000 centiStokes (cSt) at 25° C.

18. The composition of claim 17, wherein the organo-functional group R⁶-R¹⁰ are independently chosen from a C1-C13 alkyl group, a C1-C13 alkoxy group, a C2-C13 alkenyl group, a C2-C13 alkenyloxy group, a C3-C6 cycloalkyl group, a C3-C6 cycloalkoxy group, a C6-C14 aryl group, a C6-C10 aryloxy group, a C7-C13 aralkyl group, a C7-C13 aralkoxy group, a C7-C13 alkylaryl group, a C7-C13 alkylaryloxy group, and a C2-C8 ether group, or combination of two or more thereof.

19. The composition of claim 17, wherein the organo-functional silicon compound is of the formula:

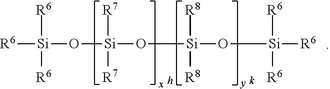

20. The composition of claim 19, wherein at least one of R⁶ is independently chosen from an alkyl, an aryl, an heteroaralkyl, an alkoxy, and an ether group.

21. The composition of claim 19, wherein at least one R⁶ group comprises the organo-functional group of the formula: 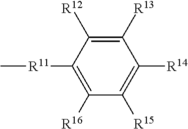
where R¹¹ is a bond or a divalent hydrocarbon and R¹², R¹³, R¹⁴, R¹⁵, and R¹⁶ are independently chosen from hydrogen, a hydroxy, an alkyl, a heteroalkyl, an alkoxy, an alkenyl, a heteroalkenyl, an alkenyloxy, a cycloalkyl, a heterocycloalkyl, a cycloalkoxy, an aryl, a heteroaryl, an aryloxy, an aralkyl, a heteroaralkyl, an alkylaryl, a heteroalkylaryl, an alkylaryloxy, an alkyl, aralkyl, alkylalkoxy, dialkoxy, heteroalkyl, heteroaryl, heteroaralkyl, or heteroalkylaryl bridge formed by one or more of R¹²-R¹³, R¹³-R¹⁴, R¹⁴-R¹⁵ and R¹⁵-R¹⁶, or a combination of two or more thereof.

22. The composition of claim 19, wherein the organo-functional silicon compound is of the formula: 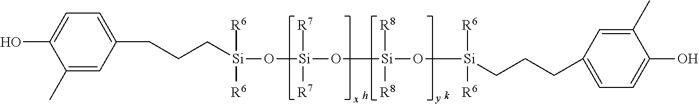
where other R⁶ is independently chosen from an alkyl, an alkoxy, an alkenyl, an alkenyloxy, a cycloalkyl, a cycloalkoxy, an aryl, an aryloxy, an aralkyl, an alkylaryl, and a alkylaryloxy.

23. The composition of claim 19, wherein the organo-functional silicon compound is of the formula:

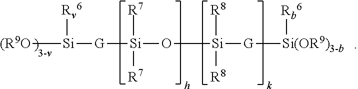

24. The composition of claim 19, wherein the organo-functional siloxane is of the formula:

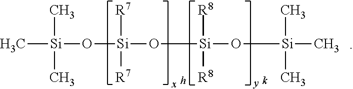

25. The composition of claim 1, wherein (G) comprises a low-molecular-weight organic polymer chosen from a polyether polyol containing repeating ether linkages —R—O—R— and having two or more hydroxyl groups as terminal functional groups, and/or a high-boiling-point solvent having a boiling point of about 150° C. or greater.

26. The composition of claim 1, comprising the organo-functional silicon compound, a high-boiling-point solvent, and/or a low-molecular-weight organic polymer in an amount of from about 0.1 to about 10 wt. per 100 pt. wt. of component (A).

27. The composition of claim 1, wherein the composition is a one-part composition.

28. The composition of claim 1, wherein the composition is a two-part composition comprising: (i) a first portion comprising the polymer component (A), optionally a filler component (E), and optionally an acidic compound (F); or (i) a first portion comprising the polymer component (A), optionally the filler component (E), and optionally, the crosslinker (B); and (ii) a second portion comprising the crosslinker (B), the cure accelerator (C), an adhesion promoter (D), the acidic compound (F), and an organo-functional silane/siloxane (G), whereby (i) and (ii) are stored separately until applied for curing by mixing of the components (i) and (ii).

29. The composition of claim 1, wherein the composition is a two-part composition comprising: (i) a first portion comprising the polymer component (A), optionally an adhesion promoter (D), and optionally an acidic compound (F); and (ii) a second portion comprising the cure accelerator (C), an organo-functional silane/siloxane (G) having at least one hydrogen, and optionally a hydride functional crosslinker (B).

30. A cured polymer formed from the composition or method of claim 1.

31. The cured polymer of claim 30 in the form of an elastomeric seal, duromeric seal, an adhesive, a coating, an encapsulant, a shaped article, a mold, or an impression material.
